(19) United States
(12) Patent Application Publication
(10) Pub. No.: US 2025/0191061 A1
(43) Pub. Date: Jun. 12, 2025

(54) APPLICATION USER INTERFACE FRAMEWORK FOR ACTIVATING REVOLVING ACCOUNTS

(71) Applicant: Synchrony Bank, Stamford, CT (US)

(72) Inventors: Syedagul Naqvi, Stamford, CT (US); Madhu Sirigiri, Stamford, CT (US); Ashok Uppalapati, Stamford, CT (US); Vamshi Veggalam, Stamford, CT (US)

(21) Appl. No.: 18/975,256

(22) Filed: Dec. 10, 2024

Related U.S. Application Data
(60) Provisional application No. 63/609,180, filed on Dec. 12, 2023.

(51) Int. Cl. G06Q 40/03; G06Q 20/22; G06Q 20/40

(52) U.S. Cl. CPC G06Q 40/03; G06Q 20/227; G06Q 20/40

(57) ABSTRACT

Disclosed embodiments may provide an application-programming interface (API) framework for activating revolving accounts. A computer-implemented method can include receiving a preapproval API response to identify a set of preapproved revolving accounts. In response to receiving a selection of a revolving account from the set of preapproved revolving accounts, an activation API request for activating the selected revolving account can be constructed. In some instances, the activation API request includes supplemental personally-identifiable information (PII) associated with the user. The computer-implemented method can also include receiving an approval API response that includes an indication that the user is approved for the selected revolving account, and the indication is determined based on a formal qualification inquiry performed on the supplemental PII.

### CROSS-REFERENCES TO RELATED APPLICATIONS

The present application claims priority from and is a non-provisional of U.S. Provisional Application No. 63/609,180, entitled “APPLICATION USER INTERFACE FRAMEWORK FOR ACTIVATING REVOLVING ACCOUNTS” filed Dec. 12, 2023, the contents of which are herein incorporated by reference in its entirety for all purposes.

### FIELD

The present disclosure relates generally to a web-server framework for activating revolving accounts. In one example, the systems and methods described herein may be used to an application programming interface for determining and activating revolving accounts based on contact data associated with a user.

### SUMMARY

Disclosed embodiments may provide an application-programming interface (API) framework for activating revolving accounts. A computer-implemented method can include receiving a preapproval application-programming interface (API) response to identify a set of preapproved revolving accounts. A preapproved revolving account of the set of preapproved revolving accounts includes revolving-account parameters identifying a line of credit and an interest rate associated with the preapproved revolving account. To receive the preapproval API response, the computer-implemented method can include receiving the contact data associated with the user, constructing an initial API request that includes the contact data, and transmitting the initial API request. When the initial API request is received, the resource server dynamically can generate in real-time the preapproval API response.

The set of preapproved revolving accounts are determined based on a pre-qualification inquiry performed on contact data associated with a user. The contact data can include name, mailing address, phone number, and email address of the user. Additionally or alternatively, the contact data can include membership information of the user, in which the membership information is associated with a particular service provider. In some instances, a data aggregation server receives the contact data and performs the pre-qualification inquiry. In some instances, the set of preapproved revolving accounts are determined by applying a machine-learning model to the contact data, in which the machine-learning model generates candidate revolving-account parameters associated with the set of preapproved revolving accounts.

The computer-implemented method can also include receiving a selection of a revolving account from the set of preapproved revolving accounts. The computer-implemented method can also include constructing an activation API request for activating the selected revolving account. In some instances, the activation API request includes supplemental personally-identifiable information (PII) associated with the user. In some instances, the supplemental PII includes date of birth and social security number associated with the user.

The computer-implemented method can also include transmitting the activation API request. When the activation API request is received, a resource server dynamically generates in real-time an approval API response to the activation API request. In some instances, the approval API response includes an indication that the user is approved for the selected revolving account, and the indication is determined based on a formal qualification inquiry performed on the supplemental PII. In some instances, a data aggregation server can receive the supplemental PII and perform the formal qualification inquiry.

The computer-implemented method can also include parsing the approval API response to identify the indication that the user is approved for the selected revolving account. The computer-implemented method can also include generating a notification that the selected revolving account has been activated according to revolving-account parameters associated with the selected revolving account.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 illustrates an example schematic diagram for activating revolving accounts based on contact data associated with a user, according to some embodiments.

FIG. 2 illustrates an example system architecture for activating revolving accounts based on contact data associated with a user, according to some embodiments.

FIG. 3 illustrates an example system architecture for using special-purpose computer for determining and activating revolving accounts based on contact data associated with a user, according to some embodiments.

FIG. 4 is a flowchart of an example process for implementing application user interface for activating revolving accounts, according to some embodiments.

FIG. 5 illustrates an example architecture of a neural network for determining preapproved revolving accounts based on contact data associated with a user, according to some embodiments.

FIG. 6 illustrates an example schematic diagram showing use cases for activating revolving accounts based on contact data, according to some embodiments.

FIG. 7 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Disclosed embodiments may provide an application-programming interface (API) framework for activating revolving accounts. An account-management application of a web server can receive contact data associated with a user. The web server can be associated with a provider of goods or services (e.g., a cloud service provider, an e-commerce website). As an illustrative example, the web server can be associated with an e-commerce website that sells various items such as electronic devices and designer clothes. The contact data can include name, mailing address, phone number, or email address of the user. Additionally or alternatively, the contact data can further identify the user's membership information associated with a particular service provider.

The account-management application can construct an initial API request to request preapproved revolving accounts associated with the user. To construct the initial API request, the account-management application can transform the contact data submitted by the user into a particular data structure, such as a JavaScript Object Notation (JSON) or an Extensible Markup Language (XML).

The account-management application can transmit the initial API request to a resource server. The resource server can be associated with a resource provider that offers revolving accounts to various users. For example, the resource server can be a financial institution that provides credit-card accounts to consumers. When the resource server receives the initial API request, the resource server can generate in real-time a preapproval API response to the initial API request. For example, the resource server can generate the preapproval API response in real-time, as the resource server receives API requests from other web servers. The non-static, real-time features of generating the preapproval API response can result in the preapproval API response at a particular time point being different from other API responses that are generated at different time points (e.g., 10 seconds before the particular time point, 10 seconds after the particular time point, 30 seconds after the particular time point, 1 minute after the particular time point).

The preapproval API response can indicate a set of preapproved revolving accounts. In some instances, a preapproved revolving account of the set of preapproved revolving accounts includes revolving-account parameters identifying a line of credit and an interest rate associated with the preapproved revolving account. For example, the preapproved revolving account can include different types of interest rates, including annual percentage rate, daily interest rate, and delinquency rates. The resource server can determine the set of preapproved revolving accounts based on limited amount of data associated with the user, which results in a decrease of the time typically needed to identify qualifying revolving accounts and protection of the user's private information as the user continues to evaluate various preapproved revolving accounts.

In some instances, the preapproval is determined by performing a pre-qualification inquiry (e.g., a soft credit check) performed on the contact data. In some instances, the resource server transmits the contact data associated with the user to a data aggregation server (e.g., a credit-bureau agency). When the data aggregation server receives the contact data, the data aggregation server can perform the pre-qualification inquiry on behalf of the resource server. Additionally or alternatively, the pre-qualification inquiry can include generating a preliminary credit report associated with the user, which can include a credit score associated with the user, a categorical value (e.g., good, very good) that identifies creditworthiness of the user, a total number of accounts opened by the user, a total amount of debt, a number of credit inquiries previously submitted by the user, and a number of missed payments.

The resource server can identify the set of preapproved revolving accounts in real-time by applying a machine-learning model to the contact data of the user. For example, the resource server can apply the machine-learning model to identify the preapproved revolving accounts in real time, as API requests from other web servers are received and processed by the resource server. In some instances, the machine-learning model generates an output that includes various candidate revolving-account parameters (e.g., interest rate, line of credit) associated with revolving accounts. The resource server can identify in real-time the set of revolving accounts based on the candidate revolving-account parameters. The non-static, real-time features of generating the candidate revolving-account parameters can result in the set of revolving accounts at a particular time point being different from other revolving accounts that are generated at different time points (e.g., 10 seconds before the particular time point, 10 seconds after the particular time point, 30 seconds after the particular time point, 1 minute after the particular time point).

The account-management application can parse the preapproval API response to identify the set of preapproved revolving accounts. In some instances, the account-management application dynamically associates the set of preapproved revolving accounts with a set of graphical user-interface elements. The set of graphical user-interface elements can then be displayed on the webpage.

The account-management application can receive a selection of a revolving account from the set of preapproved revolving accounts. The selection of the revolving account can indicate a request to activate the selected revolving account. In some instances, the selection of the revolving account is associated with a user interaction with a corresponding graphical user-interface element presented on the web page. The user interaction can include a user clicking a graphical user-interface element associated with a particular preapproved revolving account. In some instances, the account-management application indicates that the user is eligible to perform one or more transactions using a temporary credit associated with the selected preapproved revolving account. The temporary credit facilitates the user to perform the transactions while other types of qualification inquiries are performed to activate the selected preapproved revolving account.

The account-management application can dynamically construct an activation API request for activating the selected revolving account. For example, the selection of the revolving account automatically triggers the account-management application to construct and transmit the activation API request in real-time. In some instances, the activation API request additionally includes supplemental personally-identifiable information (PII) associated with the user. For example, the supplemental PII can include sensitive personal data, including date of birth and social security number associated with the user. The supplemental PII can thus provide additional information associated with the user, such that the resource provider can determine whether the selected revolving account can be activated for the user.

When the activation API request is received, the resource server can generate in real-time an approval API response to the activation API request. For example, the resource server can generate the approval API response in real-time, as the resource server receives API requests from other web servers (e.g., initial and subsequent API requests from other servers). The non-static, real-time features of generating the approval API response can result in the approval decision at a particular time point being different from decisions from other API responses that are generated at different time points (e.g., 10 seconds before the particular time point, 10 seconds after the particular time point, 30 seconds after the particular time point, 1 minute after the particular time point). The approval API response can include an indication that the user is approved for the selected revolving account. The indication can be determined based on a formal qualification inquiry (e.g., a hard credit check) performed on the supplemental PII associated with the user. After transmitting the approval API response, the resource server can activate the revolving account according to revolving-account parameters (e.g., line of credit, interest rates) associated with the selected revolving account. Additionally or alternatively, the approval API response can instead indicate that the activation API request remains pending due to the formal qualification inquiry has not been completed for the user.

In some instances, the resource server transmits the supplemental PII associated with the user to the data aggregation server. When the data aggregation server receives the supplemental PII, the data aggregation server can perform the formal qualification inquiry. The formal qualification inquiry (e.g., a hard credit check) can be performed before the resource server authorizes a lending decision, including a decision to activate the revolving account. Additionally or alternatively, the formal qualification inquiry can include generating a formal credit report associated with the user. The formal credit report can include additional amount of information relative to the preliminary credit report. The resource server can utilize the formal credit report to determine whether to activate the selected revolving account.

The account-management application can parse the approval API response to identify the indication that the user is approved for the selected revolving account. Additionally or alternatively, if the approval API response indicates that the activation API request remains pending, the account-management application can submit additional API requests to determine a status associated with the activation of the selected revolving account.

The account-management application can generate a notification that the revolving account has been activated. For example, the account-management application can transmit an email or text message to a user device, notifying that the revolving account has been activated. In another example, the account-management application can generate another web page informing the user that the selected revolving account has been activated. In yet another example, the account-management application can direct the user to a web site associated with the resource provider (e.g., automatically forward the user to the resource provider web site, provide a hyperlink to the resource provider website) to create an account with the resource provider and manage the revolving account.

### I. Application User Interface Framework for Activating Revolving Accounts

### A. Example Implementation

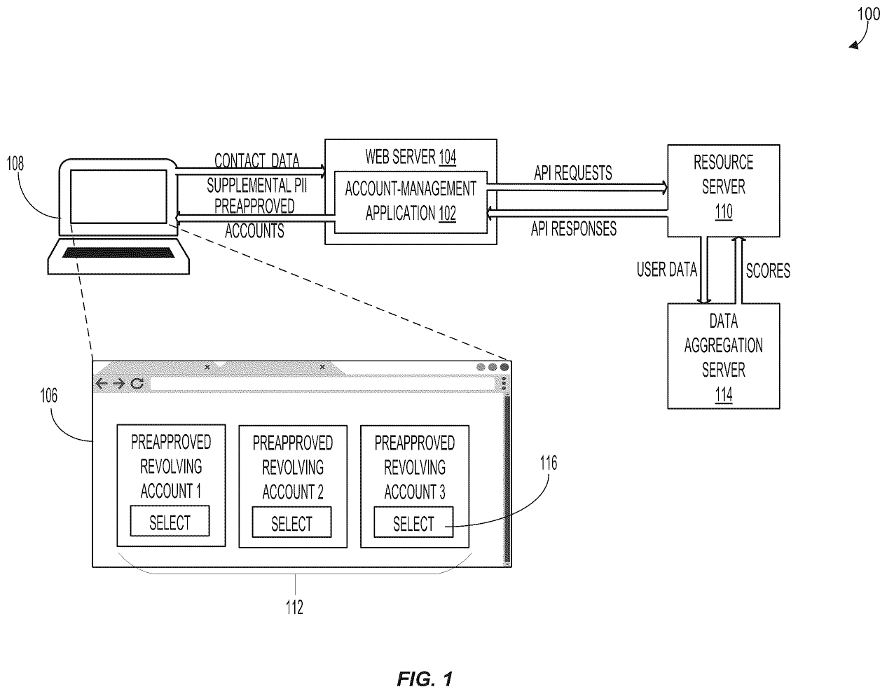

FIG. 1 illustrates an example schematic diagram 100 for activating revolving accounts based on contact data associated with a user, according to some embodiments. The example schematic diagram 100 shows an account-management application 102 of a web server 104 configured to activate revolving accounts selected by a user. To initiate the process, the account-management application 102 can receive contact data associated with a user. The web server 104 can be associated with a provider of goods or services (e.g., a cloud service provider, an e-commerce website). A browser 106 of a user device 108 can display one or more web pages transmitted by the web server 104. For example, the web server 104 can be associated with an e-commerce website, and the browser 106 can display various items sold by the corresponding provider.

In addition to the goods and services, the browser 106 can display one or more web pages associated with an offer for one or more revolving accounts. The offer for one or more revolving accounts can include an option for the user device 108 to submit contact data to determine whether the user is eligible for preapproved revolving accounts. Additionally or alternatively, the user can submit the contact data to the web server without receiving the offer, such as transmitting a request to a resource provider to receive preapproved revolving accounts. The web server 104 can determine a set of preapproved revolving accounts for the user based on performing a pre-qualification inquiry on the contact data transmitted by the user device. The contact data can include name, mailing address, phone number, or email address of the user. Additionally or alternatively, the contact data can further identify the user's membership information associated with a particular service provider.

The account-management application 102 can construct an initial API request to request preapproved revolving accounts for the user. In some instances, the initial API request includes contact data associated with a user. APIs can include mechanisms that enable two different servers (e.g., the web server 104, a resource server 110) to communicate with each other using a set of definitions and protocols. To construct the initial API request, the account-management application 102 can transform the contact data submitted by the user into a particular data structure associated with one or more API protocols (e.g., REST, RPC, SOAP). For example, the account-management application 102 can extract the name and address from the contact data to generate a JSON or XML request.

The account-management application 102 can transmit the initial API request to the resource server 110. The resource server 110 can be associated with a resource provider that offers revolving accounts to various users. For example, the resource server 110 can be a financial institution that provides credit-card accounts to consumers. When the resource server 110 receives the initial API request, the resource server 110 can generate in real-time a preapproval API response to the initial API request. For example, the resource server 110 can generate the preapproval API response in real-time, as the resource server 110 receives API requests from other web servers. In some instances, the resource server 110 can generate preapproval API responses in real-time by simultaneously processing the API requests. The non-static, real-time features of the resource server 110 generating the preapproval API response can result in the preapproval API response at a particular time point being different from other API responses that are generated by the resource server 110 at different time points (e.g., 10 seconds before the particular time point, 10 seconds after the particular time point, 30 seconds after the particular time point, 1 minute after the particular time point).

The preapproval API response can indicate a set of preapproved revolving accounts 112. In some instances, a preapproved revolving account of the set of preapproved revolving accounts 112 includes revolving-account parameters identifying a line of credit and an interest rate associated with the preapproved revolving account. For example, the preapproved revolving account can include different types of interest rates, including annual percentage rate, daily interest rate, and delinquency rates. The resource server 110 can determine the set of preapproved revolving accounts 112 based on limited amount of data associated with the user (e.g., the contact data), which results in a decrease of the time typically needed to identify qualifying revolving accounts and protection of the user's private information as the user continues to evaluate various preapproved revolving accounts.

In some instances, the preapproval is determined by performing a pre-qualification inquiry performed on the contact data. The pre-qualification inquiry (e.g., a soft credit check) can be used to determine in real-time whether a given user is preapproved for certain revolving accounts. Results from the pre-qualification inquiry can thus be generated instantaneously or within minutes (e.g., within 5 minutes) from a time point at which the pre-qualification inquiry is initiated. In some instances, the resource server 110 transmits the contact data associated with the user to a data aggregation server 114 (e.g., a credit-bureau agency). When the data aggregation server 114 receives the contact data, the data aggregation server 114 can perform the pre-qualification inquiry on behalf of the resource server 110. In some instances, the data aggregation server 114 can perform the pre-qualification inquiry by accessing additional financial metrics associated with the user.

The pre-qualification inquiry can include generating a preliminary credit report associated with the user, which can include a credit score associated with the user, a categorical value (e.g., good, very good) that identifies creditworthiness of the user, a total number of accounts opened by the user, a total amount of debt, a number of credit inquiries previously submitted by the user, and a number of missed payments. The resource server 110 can utilize the preliminary credit report to generate the set of preapproved revolving accounts 112.

The resource server 110 can identify the set of preapproved revolving accounts 112 in real-time by applying a machine-learning model to the contact data of the user. For example, the resource server 110 can apply the machine-learning model to identify the preapproved revolving accounts in real time, as API requests from other web servers (not shown) are received and processed by the resource server. To apply the machine-learning model, the resource server 110 can obtain additional data associated with the user. For example, the resource server 110 can identify a location of the user based on an Internet Protocol (IP) address indicated at a header of the initial API request. In another example, the resource server 110 can access the additional data from the preliminary credit report provided by the data aggregation server 114, including current number of opened accounts. The contact data and the additional data can be used as input to the machine-learning model, which can generate an output that includes various candidate revolving-account parameters (e.g., interest rate, line of credit) associated with revolving accounts. The resource server 110 can identify the set of revolving accounts based on the candidate revolving-account parameters. The non-static, real-time features of generating the candidate revolving-account parameters can result in the set of revolving accounts at a particular time point being different from other revolving accounts that are generated at different time points (e.g., 10 seconds before the particular time point, 10 seconds after the particular time point, 30 seconds after the particular time point, 1 minute after the particular time point).

The account-management application 102 can parse the preapproval API response to identify the set of preapproved revolving accounts 112. In some instances, the account-management application 102 dynamically associates the set of preapproved revolving accounts 112 with a set of graphical user-interface elements. The set of graphical user-interface elements can then be displayed on the browser 106. For example, the webpage associated with the account-management application 102 can display the following user-interface elements: (i) a first user-interface element corresponding to a first preapproved revolving account having a first set of revolving-account parameters; (ii) a second user-interface element corresponding to a second preapproved revolving account having a second set of revolving-account parameters; and (iii) a third user-interface element corresponding to a third preapproved revolving account having a third set of revolving-account parameters.

The account-management application 102 can receive a selection of a revolving account from the set of preapproved revolving accounts 112. The selection of the revolving account can indicate a request to activate the selected revolving account. In some instances, the selection of the revolving account is associated with a user interaction with a corresponding graphical user-interface element presented on the web page. The user interaction can include a user clicking a graphical user-interface element associated with a particular preapproved revolving account. In some instances, the user interaction includes a user selecting the particular preapproved revolving account from a drop-down menu associated with the set of preapproved revolving accounts 112. With reference to FIG. 1, the selection of the revolving account can include clicking the “Select” button displayed on a graphical user-interface element 116. In some instances, the account-management application 102 indicates that the user is eligible to perform one or more transactions using a temporary credit associated with the selected preapproved revolving account. The temporary credit facilitates the user to perform the transactions while other types of qualification inquiries are performed to activate the selected preapproved revolving account.

The account-management application 102 can dynamically construct an activation API request for activating the selected revolving account. For example, the selection of the revolving account automatically triggers the account-management application 102 to construct and transmit the activation API request in real-time. In some instances, the activation API request additionally includes supplemental personally-identifiable information (PII) associated with the user. The supplemental PII can be submitted by the user device 108, along with the selected revolving account. For example, the supplemental PII can include sensitive personal data, including date of birth and social security number associated with the user. The supplemental PII can thus provide additional information associated with the user, such that the resource provider can determine whether the selected revolving account can be activated for the user. To construct the activation API request, the account-management application 102 can transform the contact data and the supplemental PII associated with the user into a particular data structure associated with one or more API protocols (e.g., REST, RPC, SOAP).

When the activation API request is received, the resource server 110 can generate in real-time an approval API response to the activation API request. For example, the resource server 110 can generate the approval API response in real-time, as the resource server 110 receives API requests from other web servers (e.g., initial and subsequent API requests from other servers). The non-static, real-time features of generating the approval API response can result in the approval decision at a particular time point being different from decisions from other API responses that are generated at different time points (e.g., 10 seconds before the particular time point, 10 seconds after the particular time point, 30 seconds after the particular time point, 1 minute after the particular time point). The approval API response can include an indication that the user is approved for the selected revolving account. The indication can be determined based on a formal qualification inquiry (e.g., a hard credit check) performed on the supplemental PII associated with the user. After transmitting the approval API response, the resource server 110 can activate the revolving account according to revolving-account parameters (e.g., line of credit, interest rates) associated with the selected revolving account. Additionally or alternatively, the approval API response can instead indicate that the activation API request remains pending due to the formal qualification inquiry has not been completed for the user.

In some instances, the resource server 110 transmits the supplemental PII associated with the user to the data aggregation server 114. When the data aggregation server 114 receives the supplemental PII, the data aggregation server 114 can perform the formal qualification inquiry. The formal qualification inquiry (e.g., a hard credit check) can be performed before the resource server 110 authorizes a lending decision, including a decision to activate the revolving account. In some instances, the data aggregation server 114 can perform the formal qualification inquiry by combining the supplemental PII with the financial metrics of the user.

The formal qualification inquiry can include generating a formal credit report associated with the user. The formal credit report can include additional amount of information relative to the preliminary credit report. For example, the formal credit report can include a credit score associated with the user, a categorical value (e.g., good, very good) that identifies creditworthiness of the user, a total number of accounts opened by the user, a total amount of debt, a number of credit inquiries previously submitted by the user, and a number of missed payments, creditors associated with delinquent accounts, annual income of the user, employer records associated with the user, any litigation commenced against the user, specific months of missed payments. The resource server 110 can thus utilize the formal credit report to determine whether to activate the selected revolving account.

The account-management application 102 can parse the approval API response to identify the indication that the user is approved for the selected revolving account. In some instances, the approval API response indicates whether the revolving-account parameters for the selected revolving account have been modified. For example, the approval API response can indicate that that interest rate has been increased or decreased based on the formal qualification inquiry. Additionally or alternatively, if the approval API response indicates that the activation API request remains pending, the account-management application 102 can submit additional API requests to determine a status associated with the activation of the selected revolving account.

The account-management application 102 can generate a notification that the revolving account has been activated. For example, the account-management application 102 can transmit an email or text message to the user device 108, notifying that the revolving account has been activated. In another example, the account-management application 102 can generate another web page informing the user that the selected revolving account has been activated. In yet another example, the account-management application 102 can direct the user to a web site associated with the resource provider (e.g., automatically forward the user to the resource provider web site, provide a hyperlink to the resource provider website) to create an account with the resource provider and manage the revolving account.

### B. System Components for Implementing Application User Interface for Activating Revolving Accounts

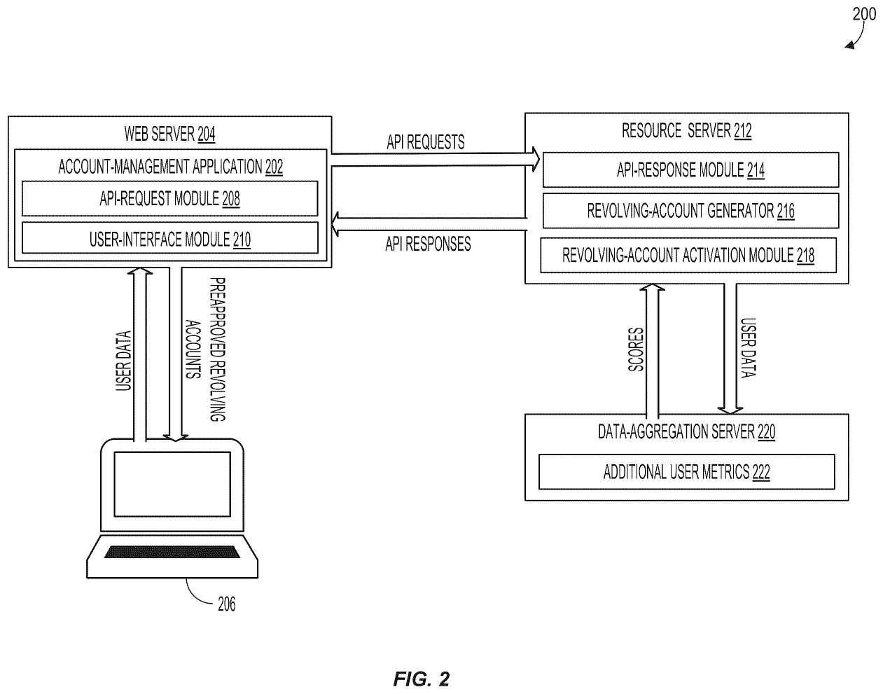

FIG. 2 illustrates an example system architecture 200 for activating revolving accounts based on contact data associated with a user, according to some embodiments. The example system architecture 200 shows an account-management application 202 of a web server 204 configured to activate revolving accounts selected by a user. To initiate the process, the account-management application 202 can receive contact data associated with a user. The web server 204 can be associated with a provider of goods or services (e.g., a cloud service provider, an e-commerce website).

In addition to the goods and services, the web server 204 can display one or more web pages associated with an offer for one or more revolving accounts. The offer for one or more revolving accounts can include an option for a user device 206 to submit contact data to determine whether the user is eligible for preapproved revolving accounts. Additionally or alternatively, the user can submit the contact data to the web server without receiving the offer, such as transmitting a request to a resource provider to receive preapproved revolving accounts. In some instances, the user device 206 can be a computing device that includes an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these.

In some instances, the user device submits the contact data using one or more requests. The request can be transmitted by the user device 206 using a transfer protocol such as Hypertext Markup Language (HTML), XML, JavaScript®, Cascading Style Sheets (CSS), JSON, and other such protocols and/or structured languages. For example, the request under an HTML protocol can be formatted as a GET request or a POST request. The contact data can include name, mailing address, phone number, or email address of the user. Additionally or alternatively, the contact data can further identify the user's membership information associated with a particular service provider. In response to the contact data submitted by the user device 206, the web server 204 can determine a set of preapproved revolving accounts for the user based on performing a pre-qualification inquiry on the contact data transmitted by the user device.

The account-management application 202 can include various modules or components to interact with the resource server 212 to activate revolving accounts for the user. For example, the account-management application 202 can include: (i) an API-request module 208 for constructing initial API requests; and (ii) a user-interface module 210 for processing preapproved revolving accounts transmitted by a resource server 212. For example, the API-request module 208 of the account-management application 202 can construct an initial API request to identify preapproved revolving accounts for the user. In some instances, the initial API request includes contact data associated with a user. To construct the initial API request, the API-request module 208 can transform the contact data submitted by the user into a particular data structure associated with one or more API protocols (e.g., REST, RPC, SOAP). As an illustrative example, the initial API request can be formatted into a JSON format as follows:

POST Quickscreen Offer Request

```
{
  “merchantInfo”:{
  “storeNumber”: “0023568955”,
  “operator”: “OPERATOR”,
  “registerNumber”: “12457845”,
  “languageCode”: “ENU”,
  “clientId”: “string”,
  “country”: “US”,
  “merchantNumber”: “1234567890123456”,
  “origination”: “I”,
    “clientData”: “samsclub”,
  },
  applicantInfo”: {
  “cipher.firstName”: “John”,
  “cipher.middleInitial”: “string”,
  “cipher.lastName”: “Smith”,
  “address”: “string”,
  “cipher.emailAddress”: “string”,
  “membership”: “123QWE-TY985555”,
  },
  “promotionInfo”: {
  “aquisitionOfferId”: “string”,
  }
  “purchaseAmount”: “5500.12”,
  “checkAccountExistence”: “True”,
}
```

The account-management application 202 can transmit the initial API request to the resource server 212 over a communication network. The network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications by the client device 206 via the network can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

The resource server 212 can be associated with a resource provider that offers revolving accounts to various users. For example, the resource server 212 can be a financial institution that provides credit-card accounts to consumers. The resource server 212 can include various modules or components to interact with the web server 204 to determine preapproved revolving accounts for the user and activate a revolving account selected from the preapproved revolving accounts. For example, the resource server 212 can include an API-response module 214 for generating API responses for the web server 204, a revolving-account generator 216 for determining a set of preapproved revolving accounts based on the contact data associated with the user, and a revolving-account activation module 219 for activating the revolving account selected from the set of preapproved revolving accounts.

When the resource server 212 receives the initial API request, the API-response module 214 can generate in real-time a preapproval API response to the initial API request. For example, the API-response module 214 can generate the preapproval API response in real-time, as the resource server 212 receives API requests from other web servers. In some instances, the API-response module 214 generates preapproval API responses in real-time by simultaneously processing the API requests. The non-static, real-time features of generating the preapproval API response can result in the preapproval API response at a particular time point being different from other API responses that are generated at different time points (e.g., 10 seconds before the particular time point, 10 seconds after the particular time point, 30 seconds after the particular time point, 1 minute after the particular time point).

The preapproval API response can indicate a set of preapproved revolving accounts, which can be generated by the revolving-account generator 216. In some instances, a preapproved revolving account of the set of preapproved revolving accounts includes revolving-account parameters, in which the revolving-account parameters identify a line of credit and an interest rate associated with the preapproved revolving account. For example, the preapproved revolving account can include different types of interest rates, including annual percentage rate, daily interest rate, and delinquency rates. The revolving-account generator 216 can determine the set of preapproved revolving accounts based on limited amount of data associated with the user (e.g., the contact data), which results in a decrease of the time typically needed to identify qualifying revolving accounts and protection of the user's private information as the user continues to evaluate various preapproved revolving accounts.

As an illustrative example, the API-response module 214 can format the API response into a JSON format as follows:

GET Quickscreen Offer Retrieval

```
{
  “decisionCode”: “0030”,
  “decisionMessage”: “APPROVED”,
  “offerId”: “55661616509969ADE68A6A8882PSR1”,
  “offerExpiryDate”: “2019-12-01”,
  “acceptanceId”: “56700045123”,
  “productCode”: “099”,
  “accountType”: “st”,
  “accountDescription”: “string”,
  “plccOfferInfo”:{
  “creditLine”: “5000.00”,
  “apr”: “18.99”,
  “dailyRate”: “0.07395”,
  },
  “dualCardOfferInfo”: {
  “creditLine”: “5000.00”,
  “tempCreditLimit”: “2000.00”,
  “apr”: “18.99”,
  “dailyRate”: “0.07395”,
  “cashAdvanceDailyRate”: “0.08243”,
  “cashAdvanceAPR”: “0.784”,
  “delinquencyApr”: “5.99”,
  “delinquencyRate”: “26.99”,
  }
}
```

In some instances, the revolving-account generator 216 determines the preapproval by performing a pre-qualification inquiry performed on the contact data. The pre-qualification inquiry (e.g., a soft credit check) can be used to determine in real-time whether a given user is preapproved for certain revolving accounts. Results from the pre-qualification inquiry can thus be generated instantaneously or within minutes (e.g., within 5 minutes) from a time point at which the pre-qualification inquiry is initiated. In some instances, the revolving-account generator 216 transmits the contact data associated with the user to a data aggregation server 220 (e.g., a credit-bureau agency). When the data aggregation server 220 receives the contact data, the data aggregation server 220 can perform the pre-qualification inquiry on behalf of the resource server 212. In some instances, the data aggregation server 220 can perform the pre-qualification inquiry by accessing additional financial metrics (e.g., additional user metrics 222) associated with the user.

The pre-qualification inquiry can include the data aggregation server 220 generating a preliminary credit report associated with the user, which can include a credit score associated with the user, a categorical value (e.g., good, very good) that identifies creditworthiness of the user, a total number of accounts opened by the user, a total amount of debt, a number of credit inquiries previously submitted by the user, and a number of missed payments. The revolving-account generator 216 can utilize the preliminary credit report to generate the set of preapproved revolving accounts.

The revolving-account generator 216 can identify the set of preapproved revolving accounts in real-time by applying a machine-learning model to the contact data of the user. For example, the revolving-account generator 216 can apply the machine-learning model to identify the preapproved revolving accounts in real time, as API requests from other web servers (not shown) are received and processed by the resource server. To apply the machine-learning model, the revolving-account generator 216 can obtain additional data associated with the user. For example, the revolving-account generator 216 can identify a location of the user based on an Internet Protocol (IP) address indicated at a header of the API request. In another example, the revolving-account generator 216 can access the additional data from the preliminary credit report provided by the data aggregation server 220, including current number of opened accounts. In yet another example, the revolving-account generator 216 can access the additional data based on the additional user metrics 222 provided by the data aggregation server 220. The contact data and the additional data can be used as input to the machine-learning model, which can generate an output that includes various candidate revolving-account parameters (e.g., interest rate, line of credit) associated with revolving accounts. The revolving-account generator 216 can identify the set of revolving accounts based on the candidate revolving-account parameters. The non-static, real-time features of generating the candidate revolving-account parameters can result in the set of revolving accounts at a particular time point being different from other revolving accounts that are generated at different time points (e.g., 10 seconds before the particular time point, 10 seconds after the particular time point, 30 seconds after the particular time point, 1 minute after the particular time point).

As an example implementation of the machine-learning model, the revolving-account generator 216 may implement a clustering algorithm to identify similarly situated user based on one or more vectors (e.g., the credit score, the total number of accounts opened by the user, the total amount of debt). In some instances, a dataset of contact data associated with sample members (e.g., testers, etc.) may be analyzed using a clustering algorithm to identify different types of members that may interact with the web server 204. Example clustering algorithms that may trained using sample member datasets (e.g., historical member data, hypothetical member data, etc.) to classify a member in order to identify categories of tasks that may be of relevance to the member may include a k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Based on the output (i.e., candidate revolving-account parameters) generated by the machine learning model, the revolving-account generator 216 can generate the set of preapproved revolving accounts.

Other examples of machine learning or artificial intelligence algorithms can also be used. For example, the machine-learning algorithms can include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

In some instances, the machine-learning models are further trained based on a loss (e.g., a cross-entropy loss) determined between the candidate revolving-account parameters and revolving-account parameters associated with accounts activated by previous users. For example, parameters of a machine-learning model (e.g., an artificial neural network) can be learned by processing the revolving-account parameters via a loss function (e.g., softmax function). Additionally or alternatively, the machine-learning models can be trained based on the revolving account that was selected and activated by the user. As a result, the machine-learning models can be optimized to generate the candidate revolving-account parameters that maximize the chances of the user selecting one of the revolving accounts offered by the resource provider.

After the resource server 212 transmits the preapproval API response, the account-management application 202 can parse the preapproval API response to identify the set of preapproved revolving accounts. In some instances, the user-interface module 210 of the account-management application 202 dynamically associates the set of preapproved revolving accounts with a set of graphical user-interface elements. The set of graphical user-interface elements can then be displayed on the browser screen. For example, the user-interface module 210 can generate and display the following user-interface elements on a given web page: (i) a first user-interface element corresponding to a first preapproved revolving account having a first set of revolving-account parameters; (ii) a second user-interface element corresponding to a second preapproved revolving account having a second set of revolving-account parameters; and (iii) a third user-interface element corresponding to a third preapproved revolving account having a third set of revolving-account parameters.

The account-management application 202 can receive a selection of a revolving account from the set of preapproved revolving accounts. The selection of the revolving account can indicate a request to activate the selected revolving account. In some instances, the selection of the revolving account is associated with the user-interface module 210 detecting a user interaction with a corresponding graphical user-interface element presented on the web page. The user interaction can include a user clicking a graphical user-interface element associated with a particular preapproved revolving account. In some instances, the user interaction includes a user selecting the particular preapproved revolving account from a drop-down menu associated with the set of preapproved revolving accounts. In some instances, the account-management application 202 indicates that the user is eligible to perform one or more transactions using a temporary credit associated with the selected preapproved revolving account. The temporary credit facilitates the user to perform the transactions while other types of qualification inquiries are performed to activate the selected preapproved revolving account.

The API-request module 208 can dynamically construct an activation API request for activating the selected revolving account. For example, the selection of the revolving account automatically triggers the API-request module 208 to construct the activation API request in real-time. In some instances, the activation API request additionally includes supplemental personally-identifiable information (PII) associated with the user. The supplemental PII can be submitted by the user device 206, along with the selected revolving account. For example, the supplemental PII can include sensitive personal data, including date of birth and social security number associated with the user. The supplemental PII can thus provide additional information associated with the user, such that the resource provider can determine whether the selected revolving account can be activated for the user. To construct the activation API request, the API-request module 208 can transform the contact data and the supplemental PII associated with the user into a particular data structure associated with one or more API protocols (e.g., REST, RPC, SOAP). As an illustrative example, the API-request module 208 can format the activation API request into a JSON format as follows:

POST Quickscreen Offer Acceptance

```
{
  “applicantInfo”: {
  “cipher.firstName”: “John”,
  “cipher.middleInitial”: “string”,
  “cipher.lastName”: “Smith”,
  “cipher.ssn”: “string”,
  “address”: “string”,
  “residenceType”: “O”,
  “cipher. emailAddress”: “string”,
  “annualIncome”: “80000.00”,
  “membership”: “123QWE-TY985555”,
  },
}
```

When the activation API request is received, the revolving-account activation module 218 of the resource server 212 can generate in real-time an approval API response to the activation API request. For example, the revolving-account activation module 218 can generate the approval API response in real-time, as the resource server 212 receives API requests from other web servers (e.g., initial and subsequent API requests from other servers). The non-static, real-time features of generating the approval API response can result in the approval decision at a particular time point being different from decisions from other API responses that are generated at different time points (e.g., 10 seconds before the particular time point, 10 seconds after the particular time point, 30 seconds after the particular time point, 1 minute after the particular time point). The approval API response can include an indication that the user is approved for the selected revolving account. The indication can be determined based on a formal qualification inquiry (e.g., a hard credit check) performed on the supplemental PII associated with the user. After transmitting the approval API response, the revolving-account activation module 218 can activate the revolving account according to revolving-account parameters (e.g., line of credit, interest rates) associated with the selected revolving account. Additionally or alternatively, the approval API response can instead indicate that the activation API request remains pending due to the formal qualification inquiry has not been completed for the user.

In some instances, the revolving-account activation module 218 transmits the supplemental PII associated with the user to the data aggregation server 220. When the data aggregation server 220 receives the supplemental PII, the data aggregation server 220 can perform the formal qualification inquiry. The formal qualification inquiry (e.g., a hard credit check) can be performed before the resource server 212 authorizes a lending decision, including a decision to activate the revolving account.

The formal qualification inquiry can include generating a formal credit report associated with the user. The formal credit report can include additional amount of information relative to the preliminary credit report. For example, the formal credit report can include a credit score associated with the user, a categorical value (e.g., good, very good) that identifies creditworthiness of the user, a total number of accounts opened by the user, a total amount of debt, a number of credit inquiries previously submitted by the user, and a number of missed payments, creditors associated with delinquent accounts, annual income of the user, employer records associated with the user, any litigation commenced against the user, specific months of missed payments. The resource server 212 can thus utilize the formal credit report to determine whether to activate the selected revolving account.

The account-management application 202 can parse the approval API response to identify the indication that the user is approved for the selected revolving account. In some instances, the approval API response indicates whether the revolving-account parameters for the selected revolving account have been modified. For example, the approval API response can indicate that that interest rate has been increased or decreased based on the formal qualification inquiry. Additionally or alternatively, if the approval API response indicates that the activation API request remains pending, the account-management application 202 can submit additional API requests to determine a status associated with the activation of the selected revolving account.

The user-interface module 210 can generate a notification that the revolving account has been activated. For example, the user-interface module 210 can transmit an email or text message to the user device 206, notifying that the revolving account has been activated. In another example, the user-interface module 210 can generate another web page informing the user that the selected revolving account has been activated. In yet another example, the user-interface module 210 can direct the user to a web site associated with the resource provider (e.g., automatically forward the user to the resource provider web site, provide a hyperlink to the resource provider website) to create an account with the resource provider and manage the revolving account.

### C. System Components and Special-Purpose Computer for Implementing Application User Interface for Activating Revolving Accounts

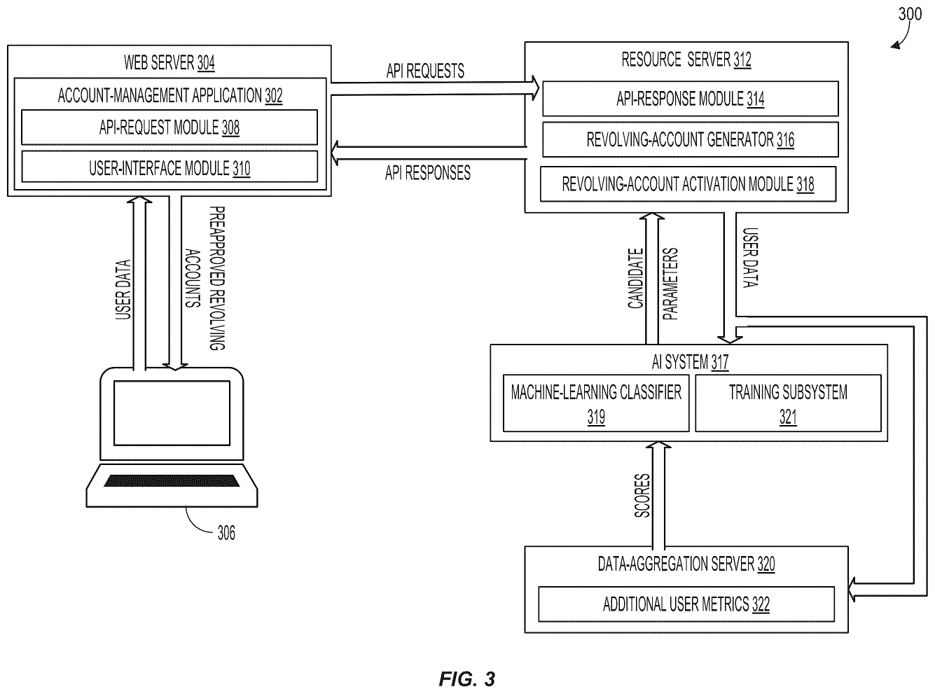

FIG. 3 illustrates an example system architecture 300 for using special-purpose computer for determining and activating revolving accounts based on contact data associated with a user, according to some embodiments. The example system architecture 300 shows an account-management application 302 of a web server 304 configured to activate revolving accounts selected by a user. To initiate the process, the account-management application 302 can receive contact data associated with a user. The web server 304 can be associated with a provider of goods or services (e.g., a cloud service provider, an e-commerce website).

In addition to the goods and services, the web server 304 can display one or more web pages associated with an offer for one or more revolving accounts. The offer for one or more revolving accounts can include an option for a user device 306 to submit contact data to determine whether the user is eligible for preapproved revolving accounts. Additionally or alternatively, the user can submit the contact data to the web server without receiving the offer, such as transmitting a request to a resource provider to receive preapproved revolving accounts. In some instances, the user device 306 can be a computing device that includes an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these.

In some instances, the user device submits the contact data using one or more requests. The request can be transmitted by the user device 306 using a transfer protocol such as HTML, XML, JavaScript®, CSS, JSON, Hypertext Markup Language (HTML), and other such protocols and/or structured languages. For example, the request under an HTML protocol can be formatted as a GET request or a POST request. The contact data can include name, mailing address, phone number, or email address of the user. Additionally or alternatively, the contact data can further identify the user's membership information associated with a particular service provider. In response to the contact data submitted by the user device 306, the web server 304 can determine a set of preapproved revolving accounts for the user based on performing a pre-qualification inquiry on the contact data transmitted by the user device.

The account-management application 302 can include various modules or components to interact with the resource server 312 to activate revolving accounts for the user. For example, the account-management application 302 can include: (i) an API-request module 308 for constructing initial API requests; and (ii) a user-interface module 310 for processing preapproved revolving accounts transmitted by a resource server 312. For example, the API-request module 308 of the account-management application 302 can construct an initial API request to identify preapproved revolving accounts for the user. In some instances, the initial API request includes contact data associated with a user. To construct the initial API request, the API-request module 308 can transform the contact data submitted by the user into a particular data structure associated with one or more API protocols (e.g., REST, RPC, SOAP). As an illustrative example, the initial API request can be formatted into a JSON format as follows:

POST Quickscreen Offer Request

```
{
  “merchantInfo”:{
  “storeNumber”: “0023568955”,
  “operator”: “OPERATOR”,
  “registerNumber”: “12457845”,
  “languageCode”: “ENU”,
  “clientId”: “string”,
  “country”: “US”,
  “merchantNumber”: “1234567890123456”,
  “origination”: “I”,
    “clientData”: “samsclub”,
  },
  “applicantInfo”: {
  “cipher.firstName”: “John”,
  “cipher.middleInitial”: “string”,
  “cipher.lastName”: “Smith”,
  “address”: “string”,
  “cipher.emailAddress”: “string”,
  “membership”: “123QWE-TY985555”,
  },
  “promotionInfo”: {
  “aquisitionOfferId”: “string”,
  }
  “purchaseAmount”: “5500.12”,
  “check AccountExistence”: “True”,
}
```

The account-management application 302 can transmit the initial API request to the resource server 312 over a communication network. The network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications by the client device 306 via the network can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

The resource server 312 can be associated with a resource provider that offers revolving accounts to various users. For example, the resource server 312 can be a financial institution that provides credit-card accounts to consumers. The resource server 312 can include various modules or components to interact with the web server 304 to determine preapproved revolving accounts for the user and activate a revolving account selected from the preapproved revolving accounts. For example, the resource server 312 can include an API-response module 314 for generating API responses for the web server 304, a revolving-account generator 316 for determining a set of preapproved revolving accounts based on the contact data associated with the user, and a revolving-account activation module 318 for activating the revolving account selected from the set of preapproved revolving accounts.

When the resource server 312 receives the initial API request, the API-response module 314 can generate in real-time a preapproval API response to the initial API request. For example, the API-response module 314 can generate the preapproval API response in real-time, as the resource server 312 receives API requests from other web servers. In some instances, the API-response module 314 generates preapproval API responses in real-time by simultaneously processing the API requests. The non-static, real-time features of generating the preapproval API response can result in the preapproval API response at a particular time point being different from other API responses that are generated at different time points (e.g., 10 seconds before the particular time point, 10 seconds after the particular time point, 30 seconds after the particular time point, 1 minute after the particular time point).

The preapproval API response can indicate a set of preapproved revolving accounts, which can be generated by the revolving-account generator 316. In some instances, a preapproved revolving account of the set of preapproved revolving accounts includes revolving-account parameters, in which the revolving-account parameters identify a line of credit and an interest rate associated with the preapproved revolving account. For example, the preapproved revolving account can include different types of interest rates, including annual percentage rate, daily interest rate, and delinquency rates. The revolving-account generator 316 can determine the set of preapproved revolving accounts based on limited amount of data associated with the user (e.g., the contact data), which results in a decrease of the time typically needed to identify qualifying revolving accounts and protection of the user's private information as the user continues to evaluate various preapproved revolving accounts.

As an illustrative example, the API-response module 314 can format the API response into a JSON format as follows:

GET Quickscreen Offer Retrieval

```
{
  “decisionCode”: “0030”,
  “decisionMessage”: “APPROVED”,
  “offerId”: “55661616509969ADE68A6A8882PSR1”,
  “offerExpiryDate”: “2019-12-01”,
  “acceptanceId”: “56700045123”,
  “productCode”: “099”,
  “accountType”: “st”,
  “accountDescription”: “string”,
  “plccOfferInfo”:{
  “creditLine”: “5000.00”,
  “apr”: “18.99”,
  “dailyRate”: “0.07395”,
  },
  “dualCardOfferInfo”: {
  “creditLine”: “5000.00”,
  “tempCreditLimit”: “2000.00”,
  ”apr”: “18.99”,
  “dailyRate”: “0.07395”,
  “cashAdvanceDailyRate”: “0.08243”,
  “cashAdvanceAPR”: “0.784”,
  “delinquencyApr”: “5.99”,
  “delinquencyRate”: “26.99”,
  }
}
```

In some instances, the revolving-account generator 316 determines the preapproval by performing a pre-qualification inquiry performed on the contact data. The pre-qualification inquiry (e.g., a soft credit check) can be used to determine in real-time whether a given user is preapproved for certain revolving accounts. Results from the pre-qualification inquiry can thus be generated instantaneously or within minutes (e.g., within 5 minutes) from a time point at which the pre-qualification inquiry is initiated. In some instances, the revolving-account generator 316 transmits the contact data associated with the user to a data aggregation server 320 (e.g., a credit-bureau agency). When the data aggregation server 320 receives the contact data, the data aggregation server 320 can perform the pre-qualification inquiry on behalf of the resource server 312. In some instances, the data aggregation server 320 can perform the pre-qualification inquiry by accessing additional financial metrics (e.g., additional user metrics 322) associated with the user.

The pre-qualification inquiry can include the data aggregation server 320 generating a preliminary credit report associated with the user, which can include a credit score associated with the user, a categorical value (e.g., good, very good) that identifies creditworthiness of the user, a total number of accounts opened by the user, a total amount of debt, a number of credit inquiries previously submitted by the user, and a number of missed payments. The revolving-account generator 316 can utilize the preliminary credit report to generate the set of preapproved revolving accounts.

The revolving-account generator 316 can identify the set of preapproved revolving accounts in real-time by interacting with an artificial intelligence (AI) system 317, which includes a machine-learning classifier 319 and a training subsystem 321. In some embodiments, the AI system 317 is implemented by a special purpose computer that is specifically configured to process the contact data and generate candidate revolving-account parameters, which can then be used to determine the set of preapproved revolving accounts. Additionally, one or more components of the AI system 317 is implemented by another special purpose computer (e.g., a training subsystem 321) that is specifically configured to train the machine-learning model using previous user data.

The machine-learning classifier 319 of the AI system 317 can retrieve and apply a trained machine-learning model to the contact data of the user to generate in real-time the candidate revolving-account parameters. For example, the machine-learning classifier 319 can apply the machine-learning model to generate the candidate revolving-account parameters in real-time, as API requests from other web servers (not shown) are received and processed by the resource server. To apply the machine-learning model, the machine-learning classifier 319 can retrieve additional data associated with the user, such that the additional data can be processed by the machine-learning model. For example, the machine-learning classifier 319 can identify a location of the user based on an Internet Protocol (IP) address indicated at a header of the API request. In another example, the machine-learning classifier 319 can access the additional data from the preliminary credit report provided by the data aggregation server 320, including current number of opened accounts. In yet another example, the machine-learning classifier 319 can access the additional data based on the additional user metrics 322 provided by the data aggregation server 320. The contact data and the additional data can be used as input to the machine-learning model, which can generate an output that includes various candidate revolving-account parameters (e.g., interest rate, line of credit) associated with revolving accounts. The revolving-account generator 316 can identify the set of revolving accounts based on the candidate revolving-account parameters. The non-static, real-time features of generating the candidate revolving-account parameters can result in the set of revolving accounts at a particular time point being different from other revolving accounts that are generated at different time points (e.g., 10 seconds before the particular time point, 10 seconds after the particular time point, 30 seconds after the particular time point, 1 minute after the particular time point).

As an example implementation of the machine-learning model, the machine-learning classifier 319 may implement a clustering algorithm to identify similarly situated user based on one or more vectors (e.g., the credit score, the total number of accounts opened by the user, the total amount of debt). In some instances, a dataset of contact data associated with sample members (e.g., testers, etc.) may be analyzed using a clustering algorithm to identify different types of members that may interact with the web server 304. Example clustering algorithms that may trained using sample member datasets (e.g., historical member data, hypothetical member data, etc.) to classify a member in order to identify categories of tasks that may be of relevance to the member may include a k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Based on the output (i.e., candidate revolving-account parameters) generated by the machine learning model, the revolving-account generator 316 can generate the set of preapproved revolving accounts.

Other examples of machine learning or artificial intelligence algorithms can also be used. For example, the machine-learning algorithms can include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

In some instances, the training subsystem 321 trains the machine-learning models based on a loss (e.g., a cross-entropy loss) determined between the candidate revolving-account parameters and revolving-account parameters associated with accounts activated by previous users. For example, parameters of a machine-learning model (e.g., an artificial neural network) can be learned by the training subsystem 321 processing the revolving-account parameters via a loss function (e.g., softmax function). Additionally or alternatively, the machine-learning models can be trained based on the revolving account that was selected and activated by the user. As a result, the training subsystem 321 can optimize the machine-learning models to generate the candidate revolving-account parameters that maximize the chances of the user selecting one of the revolving accounts offered by the resource provider.

After the resource server 312 transmits the preapproval API response, the account-management application 302 can parse the preapproval API response to identify the set of preapproved revolving accounts. In some instances, the user-interface module 310 of the account-management application 302 dynamically associates the set of preapproved revolving accounts with a set of graphical user-interface elements. The set of graphical user-interface elements can then be displayed on the browser screen. For example, the user-interface module 310 can generate and display the following user-interface elements on a given web page: (i) a first user-interface element corresponding to a first preapproved revolving account having a first set of revolving-account parameters; (ii) a second user-interface element corresponding to a second preapproved revolving account having a second set of revolving-account parameters; and (iii) a third user-interface element corresponding to a third preapproved revolving account having a third set of revolving-account parameters.

The account-management application 302 can receive a selection of a revolving account from the set of preapproved revolving accounts. The selection of the revolving account can indicate a request to activate the selected revolving account. In some instances, the selection of the revolving account is associated with the user-interface module 310 detecting a user interaction with a corresponding graphical user-interface element presented on the web page. The user interaction can include a user clicking a graphical user-interface element associated with a particular preapproved revolving account. In some instances, the user interaction includes a user selecting the particular preapproved revolving account from a drop-down menu associated with the set of preapproved revolving accounts. In some instances, the account-management application 302 indicates that the user is eligible to perform one or more transactions using a temporary credit associated with the selected preapproved revolving account. The temporary credit facilitates the user to perform the transactions while other types of qualification inquiries are performed to activate the selected preapproved revolving account.

The API-request module 308 can dynamically construct an activation API request for activating the selected revolving account. For example, the selection of the revolving account automatically triggers the API-request module 208 to construct the activation API request in real-time. In some instances, the activation API request additionally includes supplemental personally-identifiable information (PII) associated with the user. The supplemental PII can be submitted by the user device 306, along with the selected revolving account. For example, the supplemental PII can include sensitive personal data, including date of birth and social security number associated with the user. The supplemental PII can thus provide additional information associated with the user, such that the resource provider can determine whether the selected revolving account can be activated for the user. To construct the activation API request, the API-request module 308 can transform the contact data and the supplemental PII associated with the user into a particular data structure associated with one or more API protocols (e.g., REST, RPC, SOAP). As an illustrative example, the API-request module 308 can format the activation API request into a JSON format as follows:
POST Quickscreen Offer Acceptance

```
{
  “applicantInfo”: {
  “cipher.firstName”: “John”,
  “cipher.middleInitial”: “string”,
  “cipher.lastName”: “Smith”,
  “cipher.ssn”: “string”,
  “address”: “string”,
  “residenceType”: “O”,
  “cipher.emailAddress”: “string”,
  “annualIncome”: “80000.00”,
  “membership”: “123QWE-TY985555”,
  },
}
```

When the activation API request is received, the revolving-account activation module 318 of the resource server 312 can generate in real-time an approval API response to the activation API request. For example, the revolving-account activation module 318 can generate the approval API response in real-time, as the resource server receives API requests from other web servers (e.g., initial and subsequent API requests from other servers). The non-static, real-time features of generating the approval API response can result in the approval decision at a particular time point being different from decisions from other API responses that are generated at different time points (e.g., 10 seconds before the particular time point, 10 seconds after the particular time point, 30 seconds after the particular time point, 1 minute after the particular time point). The approval API response can include an indication that the user is approved for the selected revolving account. The indication can be determined based on a formal qualification inquiry (e.g., a hard credit check) performed on the supplemental PII associated with the user. After transmitting the approval API response, the revolving-account activation module 318 can activate the revolving account according to revolving-account parameters (e.g., line of credit, interest rates) associated with the selected revolving account. Additionally or alternatively, the approval API response can instead indicate that the activation API request remains pending due to the formal qualification inquiry has not been completed for the user.

In some instances, the revolving-account activation module 318 transmits the supplemental PII associated with the user to the data aggregation server 320. When the data aggregation server 320 receives the supplemental PII, the data aggregation server 320 can perform the formal qualification inquiry. The formal qualification inquiry (e.g., a hard credit check) can be performed before the resource server 312 authorizes a lending decision, including a decision to activate the revolving account.

The formal qualification inquiry can include generating a formal credit report associated with the user. The formal credit report can include additional amount of information relative to the preliminary credit report. For example, the formal credit report can include a credit score associated with the user, a categorical value (e.g., good, very good) that identifies creditworthiness of the user, a total number of accounts opened by the user, a total amount of debt, a number of credit inquiries previously submitted by the user, and a number of missed payments, creditors associated with delinquent accounts, annual income of the user, employer records associated with the user, any litigation commenced against the user, specific months of missed payments. The resource server 312 can thus utilize the formal credit report to determine whether to activate the selected revolving account.

The account-management application 302 can parse the approval API response to identify the indication that the user is approved for the selected revolving account. In some instances, the approval API response indicates whether the revolving-account parameters for the selected revolving account have been modified. For example, the approval API response can indicate that that interest rate has been increased or decreased based on the formal qualification inquiry. Additionally or alternatively, if the approval API response indicates that the activation API request remains pending, the account-management application 302 can submit additional API requests to determine a status associated with the activation of the selected revolving account.

The user-interface module 310 can generate a notification that the revolving account has been activated. For example, the user-interface module 310 can transmit an email or text message to the user device 306, notifying that the revolving account has been activated. In another example, the user-interface module 310 can generate another web page informing the user that the selected revolving account has been activated. In yet another example, the user-interface module 310 can direct the user to a web site associated with the resource provider (e.g., automatically forward the user to the resource provider web site, provide a hyperlink to the resource provider website) to create an account with the resource provider and manage the revolving account.

### II. Methods for Implementing Application User Interface for Activating Revolving Accounts

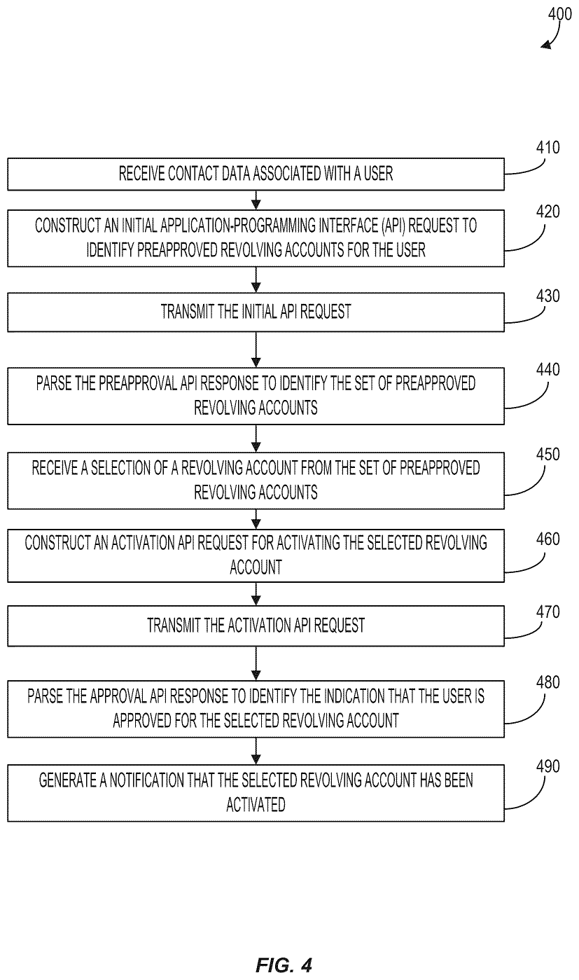

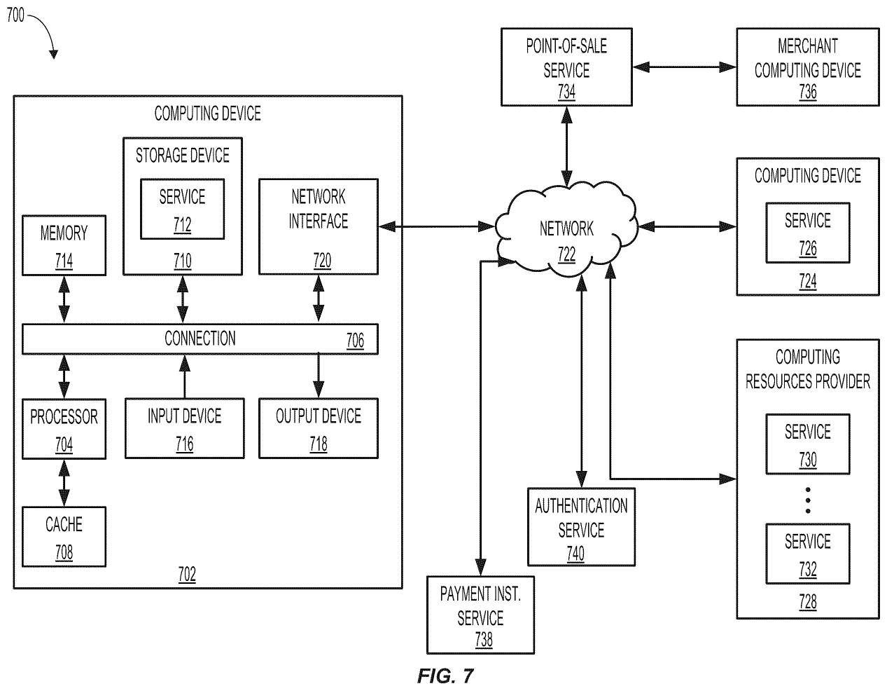

FIG. 4 is a flowchart of an example process 400 for implementing application user interface for activating revolving accounts, according to some embodiments. For illustrative purposes, the process 400 is described with reference to the components illustrated in FIGS. 2-3, though other implementations are possible. For example, the program code for the account-management application 202 of FIG. 2, is executed by one or more processing devices to cause a server system (e.g., the computing device 702 of FIG. 7) to perform one or more operations described herein.

At step 410, an account-management application associated with a web server receives contact data associated with a user. The web server can be associated with a provider of goods or services (e.g., a cloud service provider, an e-commerce website). The contact data can include name, mailing address, phone number, or email address of the user. Additionally or alternatively, the contact data can further identify the user's membership information associated with a particular service provider.

At step 420, the account-management application constructs an initial application-programming interface (API) request to identify preapproved revolving accounts for the user. In some instances, the initial API request includes contact data associated with a user. To construct the initial API request, the account-management application can transform the contact data submitted by the user into a particular data structure associated with one or more API protocols (e.g., REST, RPC, SOAP). For example, the account-management application can extract the name and address from the contact data to generate a JSON or XML request.

At step 430, the account-management application transmits the initial API request. The resource server can be associated with a resource provider that offers revolving accounts to various users. For example, the resource server can be a financial institution that provides credit-card accounts to consumers. When the resource server receives the initial API request, the resource server can generate in real-time a preapproval API response to the API request. For example, the resource server can generate the preapproval API response in real-time, as the resource server receives API requests from other web servers. In some instances, the resource server can generate preapproval API responses in real-time by simultaneously processing the API requests. The preapproval API response can indicate a set of preapproved revolving accounts. The non-static, real-time features of generating the preapproval API response can result in the preapproval API response at a particular time point being different from other API responses that are generated at different time points (e.g., 10 seconds before the particular time point, 10 seconds after the particular time point, 30 seconds after the particular time point, 1 minute after the particular time point).

In some instances, a preapproved revolving account of the set of preapproved revolving accounts includes revolving-account parameters identifying a line of credit and an interest rate associated with the preapproved revolving account. For example, the preapproved revolving account can include different types of interest rates, including annual percentage rate, daily interest rate, and delinquency rates.

In some instances, the preapproval is determined by performing a pre-qualification inquiry performed on the contact data. The pre-qualification inquiry (e.g., a soft credit check) can be used to determine in real-time whether a given user is preapproved for certain revolving accounts. Results from the pre-qualification inquiry can thus be generated instantaneously or within minutes (e.g., within 5 minutes) from a time point at which the pre-qualification inquiry is initiated. In some instances, the resource server transmits the contact data associated with the user to a data aggregation server (e.g., a credit-bureau agency). When the data aggregation server receives the contact data, the data aggregation server can perform the pre-qualification inquiry on behalf of the resource server. In some instances, the data aggregation server can perform the pre-qualification inquiry by accessing additional financial metrics associated with the user.

The resource server can identify the set of preapproved revolving accounts in real-time by applying a machine-learning model to the contact data of the user. For example, the resource server can apply the machine-learning model to identify the preapproved revolving accounts in real time, as API requests from other web servers are received and processed by the resource server. To apply the machine-learning model, the resource server can obtain additional data associated with the user. For example, the resource server can identify a location of the user based on an Internet Protocol (IP) address indicated at a header of the initial API request. In another example, the resource server can access the additional data from the preliminary credit report provided by the data aggregation server, including current number of opened accounts. The contact data and the additional data can be used as input to the machine-learning model, which can generate an output that includes various candidate revolving-account parameters (e.g., interest rate, line of credit) associated with revolving accounts. The resource server can identify the set of revolving accounts based on the candidate revolving-account parameters. The non-static, real-time features of generating the candidate revolving-account parameters can result in the set of revolving accounts at a particular time point being different from other revolving accounts that are generated at different time points (e.g., 10 seconds before the particular time point, 10 seconds after the particular time point, 30 seconds after the particular time point, 1 minute after the particular time point).

At step 440, the account-management application parses the preapproval API response to identify the set of preapproved revolving accounts. In some instances, the account-management application dynamically associates the set of preapproved revolving accounts with a set of graphical user-interface elements. The set of graphical user-interface elements can then be displayed on the webpage. For example, the webpage associated with the account-management application can display the following user-interface elements: (i) a first user-interface element corresponding to a first preapproved revolving account having a first set of revolving-account parameters; (ii) a second user-interface element corresponding to a second preapproved revolving account having a second set of revolving-account parameters; and (iii) a third user-interface element corresponding to a third preapproved revolving account having a third set of revolving-account parameters.

At step 450, the account-management application receives a selection of a revolving account from the set of preapproved revolving accounts. The selection of the revolving account can indicate a request to activate the selected revolving account. In some instances, the selection of the revolving account is associated with a user interaction with a corresponding graphical user-interface element presented on the web page. The user interaction can include a user clicking a graphical user-interface element associated with a particular preapproved revolving account. In some instances, the user interaction includes a user selecting the particular preapproved revolving account from a drop-down menu associated with the set of preapproved revolving accounts. In some instances, the account-management application indicates that the user is eligible to perform one or more transactions using a temporary credit associated with the selected preapproved revolving account. The temporary credit facilitates the user to perform the transactions while other types of qualification inquiries are performed to activate the selected preapproved revolving account.

At step 460, the account-management application dynamically constructs an activation API request for activating the selected revolving account. For example, the selection of the revolving account automatically triggers the account-management application to construct and transmit the activation API request in real-time. In some instances, the activation API request additionally includes supplemental personally-identifiable information (PII) associated with the user. For example, the supplemental PII can include sensitive personal data, including date of birth and social security number associated with the user. The supplemental PII can thus provide additional information associated with the user, such that the resource provider can determine whether the selected revolving account can be activated for the user. To construct the activation API request, the account-management application can transform the contact data and the supplemental PII associated with the user into a particular data structure associated with one or more API protocols (e.g., REST, RPC, SOAP).

At step 470, the account-management application transmits the activation API request to the resource server. When the activation API request is received, the resource server can generate in real-time an approval API response to the activation API request. For example, the resource server can generate the approval API response in real-time, as the resource server receives API requests from other web servers (e.g., initial and subsequent API requests from other servers). The non-static, real-time features of generating the approval API response can result in the approval decision at a particular time point being different from decisions from other API responses that are generated at different time points (e.g., 10 seconds before the particular time point, 10 seconds after the particular time point, 30 seconds after the particular time point, 1 minute after the particular time point). The approval API response can include an indication that the user is approved for the selected revolving account. The indication can be determined based on a formal qualification inquiry (e.g., a hard credit check) performed on the supplemental PII associated with the user. After transmitting the approval API response, the resource server can activate the revolving account according to revolving-account parameters (e.g., line of credit, interest rates) associated with the selected revolving account. Additionally or alternatively, the approval API response can instead indicate that the activation API request remains pending due to the formal qualification inquiry has not been completed for the user.

In some instances, the resource server transmits the supplemental PII associated with the user to the data aggregation server. When the data aggregation server receives the supplemental PII, the data aggregation server can perform the formal qualification inquiry. The formal qualification inquiry (e.g., a hard credit check) can be performed before the resource server authorizes a lending decision, including a decision to activate the revolving account. In some instances, the resource server transmits the supplemental PII associated with the user to the data aggregation server. Similar to the pre-qualification inquiry, the data aggregation server can perform the formal qualification inquiry on behalf of the resource server. In some instances, the data aggregation server can perform the formal qualification inquiry by combining the supplemental PII with the financial metrics of the user.

At step 480, the account-management application receives the approval API response to identify the indication that the user is approved for the selected revolving account. In some instances, the approval API response indicates whether the revolving-account parameters for the selected revolving account have been modified. For example, the approval API response can indicate that that interest rate has been increased or decreased based on the formal qualification inquiry. Additionally or alternatively, if the approval API response indicates that the activation API request remains pending, the account-management application can submit additional API requests to determine a status associated with the activation of the selected revolving account.

At step 490, the account-management application generates a notification that the selected revolving account has been activated according to revolving-account parameters associated with the selected revolving account. For example, the account-management application can transmit an email or text message to a user device, notifying that the revolving account has been activated. In another example, the account-management application can generate another web page informing the user that the selected revolving account has been activated. In yet another example, the account-management application can direct the user to a web site associated with the resource provider (e.g., automatically forward the user to the resource provider web site, provide a hyperlink to the resource provider website) to create an account with the resource provider and manage the revolving account. The process 400 can terminate thereafter.

### III. Training Machine-Learning Models for Determining Preapproved Revolving Accounts Based on User Data

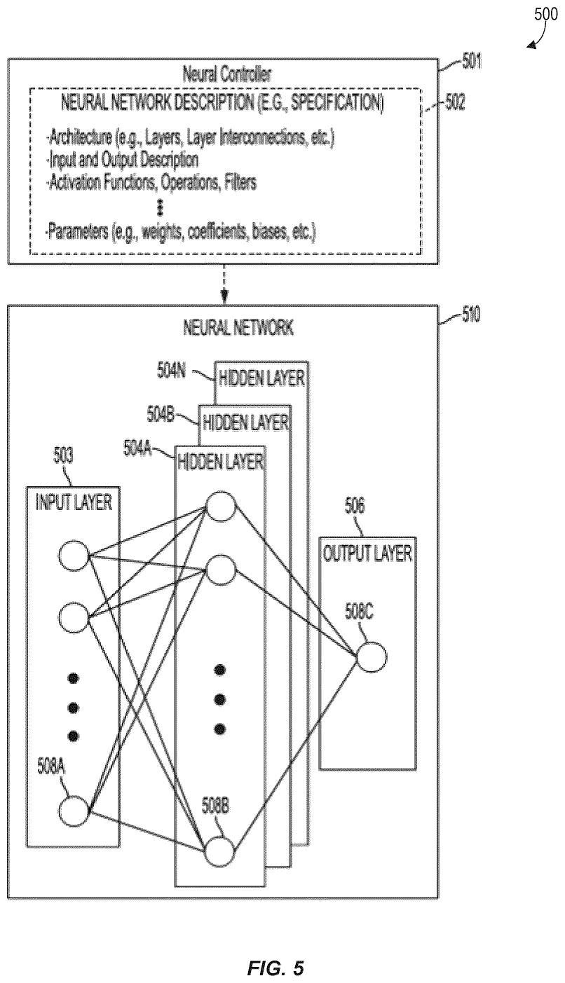

As described herein, a machine-learning model such as a clustering algorithm or a neural network can be trained to identify a set of preapproved revolving accounts for a user. FIG. 5 illustrates an example architecture 500 of a neural network 510 for determining preapproved revolving accounts based on contact data associated with a user, according to some embodiments. The neural network 510 defined by an example neural network description 502 for machine learning in a neural controller 501 (controller 501, which can be the same as a processing unit inside a mobile device). Neural network description 502 can include a full specification of the neural network 510, including the neural architecture 500. For example, the neural network description 502 can include a description or specification of architecture of the neural network 510 (e.g., the layers, layer interconnections, number of nodes in each layer, etc.); an input and output description which indicates how the input and output are formed or processed; an indication of the activation functions in the neural network, the operations or filters in the neural network, etc.; neural network revolving-account parameters such as weights, biases, etc. and so forth.

In one example, input description can include user data (e.g., the contact data) and output description can include candidate revolving-account parameters (e.g., interest rate, line of credit) associated with revolving accounts, as described above. The resource server can identify the set of preapproved revolving accounts based on the candidate revolving-account parameters. For example, a candidate revolving-account parameters can be an array of data objects, in which each data object of the array can include a line of credit and an interest rate (e.g., [7500, 24.99]). In some instances, the candidate revolving-account parameters includes other values, such as a daily interest rate, a delinquency rate, temporary line of credit, and so on. The resource server can access the data objects in the array and generate the set of preapproved revolving accounts based on the candidate revolving-account parameters. The candidate revolving-account parameters generated by the machine-learning model can increase the likelihood of the user selecting one of the preapproved revolving accounts, while decreasing the possibility of payment delinquencies.

Various training and test data sets may be utilized to train the neural network 510 such that once trained, the neural network 510 can process various aspects of the user data to determine the set of preapproved revolving accounts.

The neural network 510 can reflect the architecture 500 defined in neural network description 502. In this non-limiting example, the neural network 510 includes an input layer 503, which can process input data. The input data can be any type of data such as media content (images, videos, etc.), numbers, text, etc., associated with the user data described above with reference to FIGS. 1-4. For example, the user data can include the contact data and any additional data associated with the user, including: (i) name, mailing address, phone number, or email address of the user; (ii) credit score associated with the user; (iii) a total number of accounts opened by the user; (iv) a total amount of debt; (v) a number of credit inquiries previously submitted by the user; and (vi) a number of missed payments by the user. The user data can then be encoded into a feature vector that can be inputted into the input layer 503.

The neural network 510 can include hidden layers 504A through 504N (collectively “504” hereinafter). The hidden layers 504 can include n number of hidden layers, where n is an integer greater than or equal to one. The number of hidden layers can include as many layers as needed for a desired processing outcome and/or rendering intent. The neural network 510 further includes an output layer 506 that provides an output resulting from the processing performed by the hidden layers 504. In one illustrative example, an output layer 506 can generate the candidate revolving-account parameters to the neural network 510, in which the resource server can identify the set of preapproved revolving accounts based on the candidate revolving-account parameters.

The neural network 510, in this example, is a multi-layer neural network of interconnected nodes. Each node can represent a piece of information. Information associated with the nodes is shared among the different layers and each layer retains information as information is processed. In some cases, the neural network 510 can include a feed-forward neural network, in which case there are no feedback connections where outputs of the neural network are fed back into itself. In other cases, the neural network 510 can include a recurrent neural network, which can have loops that allow information to be carried across nodes while reading in input.

Information can be exchanged between nodes through node-to-node interconnections between the various layers. Nodes of input layer 503 can activate a set of nodes in the first hidden layer 504A. For example, as shown, each input node of input layer 503 is connected to each node of first hidden layer 504A. Nodes of hidden layer 504A can transform the information of each input node by applying activation functions to the information. The information derived from the transformation can then be passed to and can activate the nodes of the next hidden layer (e.g., 504B), which can perform their own designated functions. Example functions include convolutional, up-sampling, data transformation, pooling, and/or any other suitable functions. The output of hidden layer (e.g., 504B) can then activate nodes of the next hidden layer (e.g., 504N), and so on. The output of last hidden layer can activate one or more nodes of output layer 506, at which point an output is provided. In some cases, while nodes (e.g., nodes 508A, 508B, 508C) in the neural network 510 are shown as having multiple output lines, a node has a single output and all lines shown as being output from a node represent the same output value. The neural network 510, once trained, can have a single output that includes the candidate revolving-account parameters.

In some cases, each node or interconnection between nodes can have a weight that is a set of parameters derived from training the neural network 510. For example, an interconnection between nodes can represent a piece of information learned about the interconnected nodes. The interconnection can have a numeric weight that can be tuned (e.g., based on a training dataet), allowing the neural network 510 to be adaptive to inputs and able to learn as more data is processed.

The neural network 510 can be pre-trained to process the features from the data in the input layer 503 using different hidden layers 504 in order to provide the output through the output layer 506. For determining the set of preapproved revolving accounts, the neural network 510 may be trained as follows.

A large pool of user data corresponding to various users may be split into two classes of data called training data set and test data set. For example, 70% of the user data from the pool may be used as part of the training data set while the remaining 30% of the user data from the pool may be used as part of the test data set. The percentages according to which the user data are split into training data set and test data set is not limited to 70/30 and may be set according to a configurable accuracy requirement and/or error tolerance (e.g., the split can be 50/50, 60/40, 70/30, 80/20, 90/10, etc. between the two data sets). Supervised training techniques can be used for training and testing, in which the user data of the training dataset can be associated with corresponding training labels. The training label can include revolving-account parameters associated with one or more revolving accounts that were activated by the user.

The training data set can then be used to train the neural network 510 accompanied with manual feedback. With each output generated by the neural network 510, manual feedback can be provided to correct the output of the neural network 510, confirm the output of the neural network 510, etc. As noted, weights of different nodes of the neural network 510 may be adjusted/tuned during the training process to improve resulting output. For supervising training, the output of the machine-learning model can be compared with the revolving-account parameters indicated by the corresponding training label. The result from the comparison can be inputted into a loss function, in which the loss calculated from the result can be used to adjust the parameters of the machine-learning model. In effect, the parameters of the machine-learning model can be learned such that the candidate revolving-account parameters for the set of preapproved revolving accounts can be optimized.

Once trained, the neural network 510 can be tested using user data in test data set. Once the result of testing the neural network 510 is satisfactory (e.g., when outputs of the testing stage is greater than or equal to a threshold or incorrect detections are less than a threshold), the trained neural network 510 (which may also be referred to as a trained machine learning model or machine trained neural network) may be deployed for determining the set of preapproved revolving accounts.

In some cases, the neural network 510 can adjust weights of nodes using a training process called backpropagation. Backpropagation can include a forward pass, a loss function, a backward pass, and a weight update. The forward pass, loss function, backward pass, and parameter update can be performed for one training iteration. The process can be repeated for a certain number of iterations for each set of training media data until the weights of the layers are accurately tuned.

For example, the forward pass can include passing a training image that represent a portion of the user data through the neural network 510. The weights can be initially randomized before the neural network 510 is trained. The image can include, for example, an array of numbers representing the pixels of the image. Each number in the array can include a value from 0 to 255 describing the pixel intensity at that position in the array. In one example, the array can include a 28×28×3 array of numbers with 28 rows and 28 columns of pixels and 3 color components (such as red, green, and blue, or luma and two chroma components, or the like).

The neural network 510 can include any suitable neural or deep learning type of network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 510 can represent any other neural or deep learning network, such as an autoencoder, a deep belief nets (DBNs), a recurrent neural networks (RNNs), etc.

Neural Architecture Search (NAS) involves a process in which neural controller 501 searches through various types of neural networks such as CNNs, DBNs, RNNs, etc., to determine which type of neural network, given the input/output description of neural network description 502, can perform closes to the desired output once trained. This search process is currently cumbersome and resource intensive, because every type of available neural network is treated as a “blackbox.” In other words, a neural controller such as neural controller 501 selects an available neural network (a blackbox), trains it, validates it and either selects it or not depending on the validation result. However, each available example or type of neural network is a collection of nodes. As will be described below, the present disclosure enables gaining insight into performance of each individual node to assess its performance, which then allows the system to select of a hybrid structure of nodes that may or may not be the same as a given particular structure of a neural network currently available. In other words, the present disclosure enables an AutoML system to pick and choose nodes from different available neural networks and create a new structure that performs best for a given application.

### IV. Example Use Cases of an Application User Interface for Activating Revolving Accounts

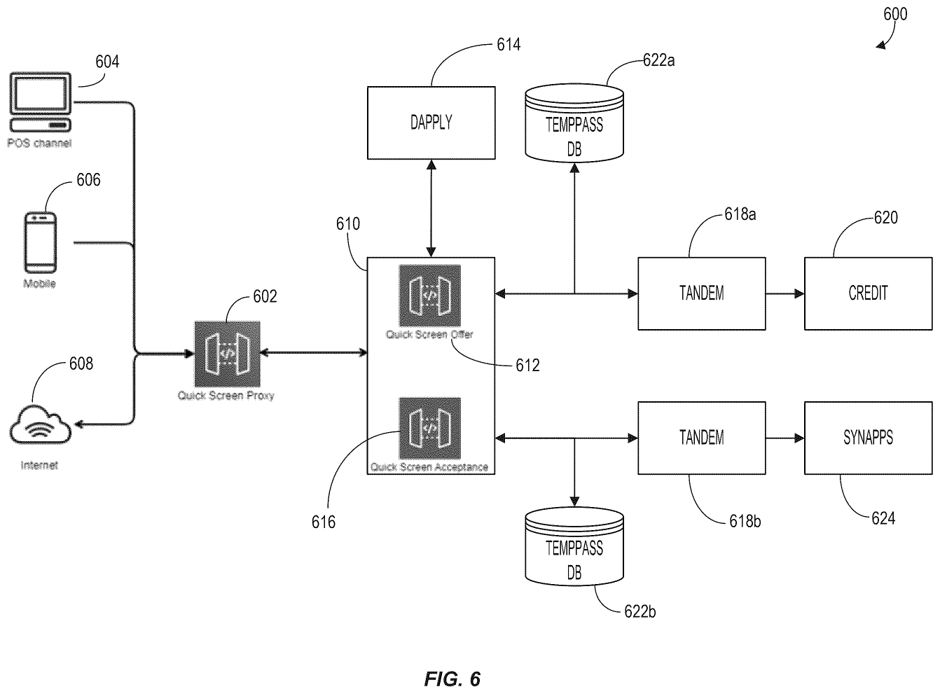

FIG. 6 illustrates an example schematic diagram 600 showing use cases for activating revolving accounts, according to some embodiments. The example schematic diagram 600 shows an API module 602 (the “Quick Screen Proxy” module) configured to communicate with devices 604 and 606, such that revolving accounts for users associated with the devices 604 and 606 can be activated. The API module 602 can be implemented on a web server. In some instances, the web server is associated with a provider of goods or services (e.g., a cloud service provider, an e-commerce website).

The web server can generate one or more web pages associated with an offer for one or more revolving accounts. The offer for one or more revolving accounts can include an option for users of the devices 604 and 606 to submit contact data to determine whether the users are eligible for preapproved revolving accounts. Additionally or alternatively, a user can submit the contact data to the web server without receiving the offer, such as transmitting a request to a resource provider to receive preapproved revolving accounts. The offer can be presented on the device 604 or 606 by its own or in combination with another content (e.g., a checkout page of a transaction). The contact data can include name, mailing address, phone number, or email address of the user.

In some instances, the devices 604 and 606 include a computing device that includes an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. For example, the device 604 can include a desktop computer, and the device 606 can include a mobile device.

In some instances, the API module 602 communicates with other devices (not shown+) connected to a network 608. The network 608 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications by the device 604 or 606 via the network can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

To activate the revolving accounts, the API module 602 can receive contact data associated with a user from the device 604 or 606. The API module 602 can construct an initial API request to obtain preapproved revolving accounts for the user. In some instances, the initial API request includes contact data associated with a user. To construct the initial API request, the API module 602 can transform the contact data submitted by the user into a particular data structure associated with one or more API protocols (e.g., REST, RPC, SOAP). In some instances, the initial API request includes additional information associated with a transaction associated with the offer, including merchant data, promotion data, a purchase amount associated with the transaction, and indication of whether the user has an existing account provided by the resource provider. The merchant data can include an identifier of the merchant and a product identifier that is associated with one or more products associated with the transaction. The initial API request can additionally include a tracking identifier of the initial API request.

The API module 602 can transmit the initial API request to a resource server 610. The resource server 610 can be associated with a resource provider that provides credit-card accounts to consumers. When the resource server 610 receives the initial API request, an offer module 612 of the resource server 610 can generate in real-time a preapproval API response to the initial API request. The preapproval API response can include an HTML approval code (e.g., “202” response code) and a set of preapproved revolving accounts. In some instances, a preapproved revolving account of the set of preapproved revolving accounts includes revolving-account parameters identifying a line of credit and an interest rate associated with the preapproved revolving account. For example, the preapproved revolving account can include different types of interest rates, including annual percentage rate, daily interest rate, and delinquency rates. The resource server 610 can determine the set of preapproved revolving accounts based on limited amount of data associated with the user (e.g., the contact data), which results in a decrease of the time typically needed to identify qualifying revolving accounts and protection of the user's private information as the user continues to evaluate various preapproved revolving accounts. In some instances, a preapproved revolving account of the set of preapproved revolving accounts is associated with an acceptance identifier.

In some instances, a screening module 614 (“DApply”) performs a pre-qualification inquiry on the contact data to generate preapproval data, which can be used by the offer module 612 to identify the set of preapproved revolving accounts. The screening module 614 can perform the pre-qualification inquiry (e.g., a soft credit check) to screen for preapproval offers or for a background check. Results from the pre-qualification inquiry can thus be generated instantaneously or within minutes (e.g., within 5 minutes) from a time point at which the pre-qualification inquiry is initiated. In some instances, the screening module 614 transmits the contact data associated with the user to a credit-bureau agency. When the credit-bureau agency receives the contact data, the credit-bureau agency can perform the pre-qualification inquiry on behalf of the resource server 610. In some instances, the screening module 614 can perform the pre-qualification inquiry by accessing additional financial metrics associated with the user.

The pre-qualification inquiry can include the screening module 614 generating a preliminary credit report associated with the user, which can include a credit score associated with the user, a categorical value (e.g., good, very good) that identifies creditworthiness of the user, a total number of accounts opened by the user, a total amount of debt, a number of credit inquiries previously submitted by the user, and a number of missed payments. The offer module 612 can utilize the preliminary credit report generated by the screening module 614 to identify the set of preapproved revolving accounts.

In some instances, the screening module 614 identifies the set of preapproved revolving accounts in real-time by applying a machine-learning model to the contact data of the user. In some instances, the machine-learning model generates an output that includes various candidate revolving-account parameters (e.g., interest rate, line of credit) associated with revolving accounts. The offer module 612 can access the candidate revolving-account parameters from the screening module 614 and identify the set of revolving accounts based on the candidate revolving-account parameters. The non-static, real-time features of generating the candidate revolving-account parameters can result in the set of revolving accounts at a particular time point being different from other revolving accounts that are generated at different time points (e.g., 60 seconds before the particular time point, 60 seconds after the particular time point, 30 seconds after the particular time point, 6 minute after the particular time point).

The API module 602 can parse the preapproval API response generated by the offer module 612 to identify the set of preapproved revolving accounts. In some instances, the web server can then associate the set of preapproved revolving accounts with a set of graphical user-interface elements. The set of graphical user-interface elements can then be displayed on a browser of the device 604 or 606.

The API module 602 can receive a selection of a revolving account from the set of preapproved revolving accounts. The selection of the revolving account can indicate a request by the device 604 or 606 to activate the selected revolving account. In some instances, the selection of the revolving account is associated with a user interaction with a corresponding graphical user-interface element presented on the web page. The user interaction can include a user clicking a graphical user-interface element associated with a particular preapproved revolving account. In some instances, the API module 602 indicates that the user is eligible to perform one or more transactions using a temporary credit associated with the selected preapproved revolving account. The temporary credit facilitates the user to perform the transactions while other types of qualification inquiries are performed to activate the selected preapproved revolving account.

In response to the selection, the API module 602 can dynamically construct an activation API request for activating the selected revolving account. For example, the selection of the revolving account automatically triggers the API module 602 to construct and transmit the activation API request to the resource server 610 in real-time. In some instances, the activation API request additionally includes supplemental personally-identifiable information (PII) associated with the user. The supplemental PII can include sensitive personal data, including date of birth and social security number associated with the user. As described above, the supplemental PII can thus provide additional information associated with the user, such that the resource provider can determine whether the selected revolving account can be activated for the user. To construct the activation API request, the API module 602 can transform the contact data and the supplemental PII associated with the user into a particular data structure associated with one or more API protocols (e.g., REST, RPC, SOAP). As an illustrative example, the activation API request can include an acceptance identifier associated with the selected revolving account, supplemental PII including social security number of the user, and the merchant data.

When the activation API request is received, an acceptance module 616 of the resource server 610 can generate in real-time an approval API response to the activation API request. The approval API response can include an indication that the user is approved for the selected revolving account. The indication can be determined based on a formal qualification inquiry (e.g., a hard credit check) performed on the supplemental PII associated with the user. The acceptance module 616 can transmit the approval API response to the API module 602. Once the approval API response is transmitted, the resource server 610 can activate the revolving account according to revolving-account parameters (e.g., line of credit, interest rates) associated with the selected revolving account. In some instances, the resource server 610 transmits a revolving-account activation request to a communication module 618a (a “Tandem” module), at which the communication module 618a can generate and transmit instructions to one or more microservices to perform various functions relating to the revolving account. For example, the communication module 618a can transmit instructions a credit microservice 620 (“Credit”) to activate the selected revolving account for the user. In some instances, the communication module 618a authenticates the revolving-account activation request based on a temporary passcode or any authentication tokens associated with the revolving-account activation request, in which the authentication tokens can be accessed from a passcode database 622a.

In some instances, the acceptance module 616 transmits the supplemental PII associated with the user to the screening module 614. When the supplemental PII is received, the screening module 614 can perform the formal qualification inquiry. The screening module 614 can perform the formal qualification inquiry (e.g., a hard credit check) before the acceptance module 616 authorizes a lending decision, including a decision to activate the revolving account. The formal qualification inquiry can include generating a formal credit report associated with the user. The formal credit report can include additional amount of information relative to the preliminary credit report. For example, the formal credit report can include a credit score associated with the user, a categorical value (e.g., good, very good) that identifies creditworthiness of the user, a total number of accounts opened by the user, a total amount of debt, a number of credit inquiries previously submitted by the user, and a number of missed payments, creditors associated with delinquent accounts, annual income of the user, employer records associated with the user, any litigation commenced against the user, specific months of missed payments. In some instances, the screening module 614 can perform the formal qualification inquiry by combining the supplemental PII with the financial metrics of the user.

The API module 602 can parse the approval API response to identify the indication that the user is approved for the selected revolving account. In some instances, the approval API response indicates whether the revolving-account parameters for the selected revolving account have been modified. For example, the approval API response can indicate that that interest rate has been increased or decreased based on the formal qualification inquiry.

Additionally or alternatively, if the approval API response indicates that the activation API request remains pending, the API module 602 can submit additional API requests to determine a status associated with the activation of the selected revolving account.

After the account activation, the resource server 610 can perform various functions associated with the activated revolving account. In some instances, the resource server 610 communicates with microservices to functions associated with the activated revolving account (e.g., update user information, update financial metrics) For example, the resource server 610 can transmit one or more requests to another communication module 618b (another “Tandem” module), at which the communication module 618a can generate and transmit instructions to microservices 624 (“Synapps”) to perform various functions relating to the revolving account. In some instances, the communication module 618b authenticates the requests generated by the resource server 610 based on a temporary passcode or other authentication tokens, in which the authentication tokens can be accessed from a passcode database 622b.

### V. Example Systems

FIG. 7 illustrates a computing system architecture 700, including various components in electrical communication with each other, in accordance with some embodiments. The example computing system architecture 700 illustrated in FIG. 7 includes a computing device 702, which has various components in electrical communication with each other using a connection 706, such as a bus, in accordance with some implementations. The example computing system architecture 700 includes a processing unit 704 that is in electrical communication with various system components, using the connection 706, and including the system memory 714. In some embodiments, the system memory 714 includes read-only memory (ROM), random-access memory (RAM), and other such memory technologies including, but not limited to, those described herein. In some embodiments, the example computing system architecture 700 includes a cache 708 of high-speed memory connected directly with, in close proximity to, or integrated as part of the processor 704. The system architecture 700 can copy data from the memory 714 and/or the storage device 710 to the cache 708 for quick access by the processor 704. In this way, the cache 708 can provide a performance boost that decreases or eliminates processor delays in the processor 704 due to waiting for data. Using modules, methods and services such as those described herein, the processor 704 can be configured to perform various actions. In some embodiments, the cache 708 may include multiple types of cache including, for example, level one (L1) and level two (L2) cache. The memory 714 may be referred to herein as system memory or computer system memory. The memory 714 may include, at various times, elements of an operating system, one or more applications, data associated with the operating system or the one or more applications, or other such data associated with the computing device 702.

Other system memory 714 can be available for use as well. The memory 714 can include multiple different types of memory with different performance characteristics. The processor 704 can include any general purpose processor and one or more hardware or software services, such as service 712 stored in storage device 710, configured to control the processor 704 as well as a special-purpose processor where software instructions are incorporated into the actual processor design. The processor 704 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 704 can be a microprocessor, a microcontroller, a digital signal processor (“DSP”), or a combination of these and/or other types of processors. In some embodiments, the processor 704 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 700, an input device 716 can represent any number of input mechanisms, such as a microphone for speech, a touch-sensitive screen for gesture or graphical input, keyboard, mouse, motion input, pen, and other such input devices. An output device 718 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 700. In some embodiments, the input device 716 and/or the output device 718 can be coupled to the computing device 702 using a remote connection device such as, for example, a communication interface such as the network interface 720 described herein. In such embodiments, the communication interface can govern and manage the input and output received from the attached input device 716 and/or output device 718. As may be contemplated, there is no restriction on operating on any particular hardware arrangement and accordingly the basic features here may easily be substituted for other hardware, software, or firmware arrangements as they are developed.

In some embodiments, the storage device 710 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described herein, the storage device 710 can include hardware and/or software services such as service 712 that can control or configure the processor 704 to perform one or more functions including, but not limited to, the methods, processes, functions, systems, and services described herein in various embodiments. In some embodiments, the hardware or software services can be implemented as modules. As illustrated in example computing system architecture 700, the storage device 710 can be connected to other parts of the computing device 702 using the system connection 706. In an embodiment, a hardware service or hardware module such as service 712, that performs a function can include a software component stored in a non-transitory computer-readable medium that, in connection with the necessary hardware components, such as the processor 704, connection 706, cache 708, storage device 710, memory 714, input device 716, output device 718, and so forth, can carry out the functions such as those described herein.

The disclosed techniques for implementing application user interface for activating revolving accounts can be performed using a computing system such as the example computing system illustrated in FIG. 7, using one or more components of the example computing system architecture 700. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for dynamically, and in real-time, identifying one or more conditions associated with an obtained invoice described herein by, for example, executing code using a processor such as processor 704 wherein the code is stored in memory such as memory 714 as described herein. One or more of a user device, a provider server or system, a database system, or other such devices, services, or systems may include some or all of the components of the computing system such as the example computing system illustrated in FIG. 7, using one or more components of the example computing system architecture 700 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 728. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 704 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 714 can be coupled to the processor 704 by, for example, a connector such as connector 706, or a bus. As used herein, a connector or bus such as connector 706 is a communications system that transfers data between components within the computing device 702 and may, in some embodiments, be used to transfer data between computing devices. The connector 706 can be a data bus, a memory bus, a system bus, or other such data transfer mechanism. Examples of such connectors include, but are not limited to, an industry standard architecture (ISA” bus, an extended ISA (EISA) bus, a parallel AT attachment (PATA” bus (e.g., an integrated drive electronics (IDE) or an extended IDE (EIDE) bus), or the various types of parallel component interconnect (PCI) buses (e.g., PCI, PCIe, PCI-104, etc.).

The memory 714 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 714 can also include magnetic or optical data storage media including read-only (e.g., CD ROM and DVD ROM) or otherwise (e.g., CD or DVD). The memory can be local, remote, or distributed.

As described herein, the connector 706 (or bus) can also couple the processor 704 to the storage device 710, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 710. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 706 can also couple the processor 704 to a network interface device such as the network interface 720. The interface can include one or more of a modem or other such network interfaces including, but not limited to those described herein. It will be appreciated that the network interface 720 may be considered to be part of the computing device 702 or may be separate from the computing device 702. The network interface 720 can include one or more of an analog modem, Integrated Services Digital Network (ISDN) modem, cable modem, token ring interface, satellite transmission interface, or other interfaces for coupling a computer system to other computer systems. In some embodiments, the network interface 720 can include one or more input and/or output (I/O) devices. The I/O devices can include, by way of example but not limitation, input devices such as input device 716 and/or output devices such as output device 718. For example, the network interface 720 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 702 can be connected to one or more additional computing devices such as computing device 724 via a network 722 using a connection such as the network interface 720. In such embodiments, the computing device 724 may execute one or more services 726 to perform one or more functions under the control of, or on behalf of, programs and/or services operating on computing device 702. In some embodiments, a computing device such as computing device 724 may include one or more of the types of components as described in connection with computing device 702 including, but not limited to, a processor such as processor 704, a connection such as connection 706, a cache such as cache 708, a storage device such as storage device 710, memory such as memory 714, an input device such as input device 716, and an output device such as output device 718. In such embodiments, the computing device 724 can carry out the functions such as those described herein in connection with computing device 702. In some embodiments, the computing device 702 can be connected to a plurality of computing devices such as computing device 724, each of which may also be connected to a plurality of computing devices such as computing device 724. Such an embodiment may be referred to herein as a distributed computing environment.

The network 722 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 722 can be wired connections, wireless connections, or combinations thereof. Communications via the network 722 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 722, within the computing device 702, within the computing device 724, or within the computing resources provider 728 can include information, which also may be referred to herein as content. The information may include text, graphics, audio, video, haptics, and/or any other information that can be provided to a user of the computing device such as the computing device 702. In an embodiment, the information can be delivered using a transfer protocol such as HTML, XML, JavaScript®, CSS, JSON, and other such protocols and/or structured languages. The information may first be processed by the computing device 702 and presented to a user of the computing device 702 using forms that are perceptible via sight, sound, smell, taste, touch, or other such mechanisms. In some embodiments, communications over the network 722 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 702 and/or the computing device 724 can be connected to a computing resources provider 728 via the network 722 using a network interface such as those described herein (e.g. network interface 720). In such embodiments, one or more systems (e.g., service 730 and service 732) hosted within the computing resources provider 728 (also referred to herein as within “a computing resources provider environment”) may execute one or more services to perform one or more functions under the control of, or on behalf of, programs and/or services operating on computing device 702 and/or computing device 724. Systems such as service 730 and service 732 may include one or more computing devices such as those described herein to execute computer code to perform the one or more functions under the control of, or on behalf of, programs and/or services operating on computing device 702 and/or computing device 724.

For example, the computing resources provider 728 may provide a service, operating on service 730 to store data for the computing device 702 when, for example, the amount of data that the computing device 702 exceeds the capacity of storage device 710. In another example, the computing resources provider 728 may provide a service to first instantiate a virtual machine (VM) on service 732, use that VM to access the data stored on service 732, perform one or more operations on that data, and provide a result of those one or more operations to the computing device 702. Such operations (e.g., data storage and VM instantiation) may be referred to herein as operating “in the cloud,” “within a cloud computing environment,” or “within a hosted virtual machine environment,” and the computing resources provider 728 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 728 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, serverless hosting, virtual reality (VR) systems, and augmented reality (AR) systems. Various techniques to facilitate such services include, but are not limited to, virtual machines, virtual storage, database services, system schedulers (e.g., hypervisors), resource management systems, various types of short-term, mid-term, long-term, and archival storage devices, etc.

As may be contemplated, the systems such as service 730 and service 732 may implement versions of various services (e.g., the service 712 or the service 726) on behalf of, or under the control of, computing device 702 and/or computing device 724. Such implemented versions of various services may involve one or more virtualization techniques so that, for example, it may appear to a user of computing device 702 that the service 712 is executing on the computing device 702 when the service is executing on, for example, service 730. As may also be contemplated, the various services operating within the computing resources provider 728 environment may be distributed among various systems within the environment as well as partially distributed onto computing device 724 and/or computing device 702.

In an embodiment, the computing device 702 can be connected to one or more additional computing devices and/or services such as merchant computing device 736 and/or a point-of-sale service 734 via the network 722 and using a connection such as the network interface 720. In an embodiment, the point-of-sale service 734 is separate from the merchant computing device 736. In an embodiment, the point-of-sale service 734 is executing on the merchant computing device 736. In an embodiment, the point-of-sale service 734 is executing as one or more services (e.g., the service 730 and/or the service 732) operating within the environment of the computing resources provider. As used herein, a point-of-sale service 734 is a service used by one or more merchants to manage sales transactions for customers, to process payment transactions for customers (e.g., payment instrument transactions), to manage inventory for merchants, to identify customers based on, for example, customer loyalty programs, and other such tasks.

In an embodiment, a customer and/or a merchant uses the merchant computing device 736 to interact with the point-of-sale service 734. In an embodiment, the merchant computing device 736 is a dedicated point-of-service (POS) terminal. In an embodiment, the merchant computing device 736 is a cash register system. In an embodiment, the merchant computing device 736 is an application or web service operating on a computing device such as the computing device 702 described herein. In such an embodiment, the application or web service may be provided by a financial services system (e.g., a bank, a transaction processing system, an inventory management system, or some other such financial services system). In an embodiment, the merchant computing device 736 includes an auxiliary device or system to execute tasks associated with the point-of-sale service 734 (e.g., a payment instrument processing device attached to a smart phone or tablet). In an embodiment, the merchant computing device 736 is a kiosk that is located at a merchant location (e.g., in a merchant's “brick and mortar” store), in a high traffic area (e.g., in a mall or in an airport concourse), or at some other such location. In such an embodiment, the kiosk may include additional branding elements to allow associating the kiosk with a vendor. In an embodiment, the merchant computing device 736 is a virtual device (e.g., a virtual kiosk) such as the virtual devices described herein. Although not illustrated here, in an embodiment, the merchant computing device 736 may be one of a plurality of devices that may be interconnected using a network such as the network 722.

In an embodiment, the computing device 702 can be connected to one or more additional computing devices and/or services such as a payment instrument service 738 via the network 722 and using a connection such as the network interface 720. In an embodiment, the payment instrument service 738 connects directly with the point of sale service 734. In an embodiment, elements of the payment instrument service 738 are executing on the merchant computing device 736. In an embodiment, the payment instrument service 738 is executing as one or more services (e.g., the service 730 and/or the service 732) operating within the environment of the computing resources provider. As used herein, a payment instrument service 738 is a service used by various entities (e.g., merchants, financial institutions, and account holders) to manage payment instrument transactions (e.g., sales and payments), process payment, to issue payment instruments to account holders, and to perform other such actions.

In an embodiment, elements of the payment instrument service 738 are running as an application or web service operating on a computing device such as the computing device 702 described herein. In such an embodiment, the application or web service of the payment instrument service 738 may be provided by a financial services system (e.g., a bank, a transaction processing system, an inventory management system, or some other such financial services system). In an embodiment, elements of the payment instrument service 738 are running on an auxiliary device or system configured to execute tasks associated with the payment instrument service 738 (e.g., uses a payment instrument processing device attached to a smart phone or tablet). In an embodiment, elements of the payment instrument service 738 are running on virtual device such as those described herein. Although not illustrated here, in an embodiment, the payment instrument service 738 may be running on one or more of a plurality of devices that may be interconnected using a network such as the network 722.

In an embodiment, the computing device 702 can be connected to one or more additional computing devices and/or services such as an authentication service 740 via the network 722 and using a connection such as the network interface 720. In an embodiment, the authentication service 740 is an element of the payment instrument service 738. In an embodiment, the authentication service 740 is separate from the payment instrument service 738. In an embodiment, the authentication service 740 connects directly with the point of sale service 734. In an embodiment, elements of the authentication service 740 are executing on the merchant computing device 736. In an embodiment, the authentication service 740 is executing as one or more services (e.g., the service 730 and/or the service 732) operating within the environment of the computing resources provider. As used herein, an authentication service 740 is a service used by one or more merchants to authenticate transactions associated with payment instruments. An authentication service may be a third-party service that provides secure and verified authorization of the transactions.

In an embodiment, elements of the authentication service 740 are running as an application or web service operating on a computing device such as the computing device 702 described herein. In such an embodiment, the application or web service of the authentication service 740 may be provided by a financial services system (e.g., a bank, a transaction processing system, an inventory management system, or some other such financial services system). In an embodiment, elements of the authentication service 740 are running on an auxiliary device or system configured to execute tasks associated with the authentication service 740 (e.g., provides authentication using payment instrument processing device attached to a smart phone or tablet). In an embodiment, elements of the authentication service 740 are running on virtual device such as those described herein. Although not illustrated here, in an embodiment, the authentication service 740 may be running on one or more of a plurality of devices that may be interconnected using a network such as the network 722.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 702) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described herein. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram. Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, liner classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described herein generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistant (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 702.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described herein. The elements and acts of the various examples described herein can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described herein to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 35 U.S.C. § 1124 will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described herein may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use.

What is claimed is:

1. A computer-implemented method comprising:
receiving a preapproval application-programming interface (API) response to identify a set of preapproved revolving accounts, wherein the set of preapproved revolving accounts are determined based on a pre-qualification inquiry performed on contact data associated with a user;
receiving a selection of a revolving account from the set of preapproved revolving accounts;
constructing an activation API request for activating the selected revolving account, wherein the activation API request includes supplemental personally-identifiable information (PII) associated with the user;
transmitting the activation API request, wherein when the activation API request is received, a resource server dynamically generates in real-time an approval API response to the activation API request, wherein the approval API response includes an indication that the user is approved for the selected revolving account, and wherein the indication is determined based on a formal qualification inquiry performed on the supplemental PII;
parsing the approval API response to identify the indication that the user is approved for the selected revolving account; and
generating a notification that the selected revolving account has been activated according to revolving-account parameters associated with the selected revolving account.

2. The computer-implemented method of claim 1, wherein receiving the preapproval API response includes:
transmitting the contact data associated with the user, wherein when a data aggregation server receives the contact data, the data aggregation server performs the pre-qualification inquiry.

3. The computer-implemented method of claim 1, wherein the set of preapproved revolving accounts are determined by applying a machine-learning model to the contact data, wherein the machine-learning model generates candidate revolving-account parameters associated with the set of preapproved revolving accounts.

4. The computer-implemented method of claim 1, wherein generating the approval API response includes:
transmitting the supplemental PII associated with the user, wherein when a data aggregation server receives the supplemental PII, the data aggregation server performs the formal qualification inquiry.

5. The computer-implemented method of claim 1, wherein a preapproved revolving account of the set of preapproved revolving accounts includes revolving-account parameters identifying a line of credit and an interest rate associated with the preapproved revolving account.

6. The computer-implemented method of claim 1, wherein the contact data includes name, mailing address, phone number, and email address of the user.

7. The computer-implemented method of claim 1, wherein the contact data includes membership information of the user, wherein the membership information is associated with a particular service provider.

8. The computer-implemented method of claim 1, wherein the supplemental PII includes date of birth and social security number associated with the user.

9. The computer-implemented method of claim 1, wherein receiving the preapproval API response further includes:
receiving the contact data associated with the user;
constructing an initial API request, wherein the initial API request includes the contact data; and
transmitting the initial API request, wherein when the initial API request is received, the resource server dynamically generates in real-time the preapproval API response, and wherein the preapproval API response includes the set of preapproved revolving accounts.

10. A system, comprising:
one or more processors; and
memory storing thereon instructions that, as a result of being executed by the one or more processors, cause the system to perform operations comprising:
receiving a preapproval application-programming interface (API) response to identify a set of preapproved revolving accounts, wherein the set of preapproved revolving accounts are determined based on a pre-qualification inquiry performed on contact data associated with a user;
receiving a selection of a revolving account from the set of preapproved revolving accounts;
constructing an activation API request for activating the selected revolving account, wherein the activation API request includes supplemental personally-identifiable information (PII) associated with the user;
transmitting the activation API request, wherein when the activation API request is received, a resource server dynamically generates in real-time an approval API response to the activation API request, wherein the approval API response includes an indication that the user is approved for the selected revolving account, and wherein the indication is determined based on a formal qualification inquiry performed on the supplemental PII;
parsing the approval API response to identify the indication that the user is approved for the selected revolving account; and
generating a notification that the selected revolving account has been activated according to revolving-account parameters associated with the selected revolving account.

11. The system of claim 10, wherein receiving the preapproval API response includes:
transmitting the contact data associated with the user, wherein when a data aggregation server receives the contact data, the data aggregation server performs the pre-qualification inquiry.

12. The system of claim 10, wherein the set of preapproved revolving accounts are determined by applying a machine-learning model to the contact data, wherein the machine-learning model generates candidate revolving-account parameters associated with the set of preapproved revolving accounts.

13. The system of claim 10, wherein generating the approval API response includes:
transmitting the supplemental PII associated with the user, wherein when a data aggregation server receives the supplemental PII, the data aggregation server performs the formal qualification inquiry.

14. The system of claim 10, wherein a preapproved revolving account of the set of preapproved revolving accounts includes revolving-account parameters identifying a line of credit and an interest rate associated with the preapproved revolving account.

15. The system of claim 10, wherein the contact data includes name, mailing address, phone number, and email address of the user.

16. The system of claim 10, wherein the contact data includes membership information of the user, wherein the membership information is associated with a particular service provider.

17. The system of claim 10, wherein the supplemental PII includes date of birth and social security number associated with the user.

18. The system of claim 10, wherein receiving the preapproval API response further includes:
receiving the contact data associated with the user;
constructing an initial API request, wherein the initial API request includes the contact data; and
transmitting the initial API request, wherein when the initial API request is received, the resource server dynamically generates in real-time the preapproval API response, and wherein the preapproval API response includes the set of preapproved revolving accounts.

19. A non-transitory, computer-readable storage medium storing thereon executable instructions that, as a result of being executed by one or more processors of a computer system, cause the computer system to perform operations comprising:
receiving a preapproval application-programming interface (API) response to identify a set of preapproved revolving accounts, wherein the set of preapproved revolving accounts are determined based on a pre-qualification inquiry performed on contact data associated with a user;
receiving a selection of a revolving account from the set of preapproved revolving accounts;
constructing an activation API request for activating the selected revolving account, wherein the activation API request includes supplemental personally-identifiable information (PII) associated with the user;
transmitting the activation API request, wherein when the activation API request is received, a resource server dynamically generates in real-time an approval API response to the activation API request, wherein the approval API response includes an indication that the user is approved for the selected revolving account, and wherein the indication is determined based on a formal qualification inquiry performed on the supplemental PII;
parsing the approval API response to identify the indication that the user is approved for the selected revolving account; and
generating a notification that the selected revolving account has been activated according to revolving-account parameters associated with the selected revolving account.

20. The non-transitory, computer-readable storage medium of claim 19, wherein receiving the preapproval API response includes:
transmitting the contact data associated with the user, wherein when a data aggregation server receives the contact data, the data aggregation server performs the pre-qualification inquiry.

21. The non-transitory, computer-readable storage medium of claim 19, wherein the set of preapproved revolving accounts are determined by applying a machine-learning model to the contact data, wherein the machine-learning model generates candidate revolving-account parameters associated with the set of preapproved revolving accounts.

22. The non-transitory, computer-readable storage medium of claim 19, wherein generating the approval API response includes:
transmitting the supplemental PII associated with the user, wherein when a data aggregation server receives the supplemental PII, the data aggregation server performs the formal qualification inquiry.

23. The non-transitory, computer-readable storage medium of claim 19, wherein a preapproved revolving account of the set of preapproved revolving accounts includes revolving-account parameters identifying a line of credit and an interest rate associated with the preapproved revolving account.

24. The non-transitory, computer-readable storage medium of claim 19, wherein the contact data includes name, mailing address, phone number, and email address of the user.

25. The non-transitory, computer-readable storage medium of claim 19, wherein the contact data includes membership information of the user, wherein the membership information is associated with a particular service provider.

26. The non-transitory, computer-readable storage medium of claim 19, wherein the supplemental PII includes date of birth and social security number associated with the user.

27. The non-transitory, computer-readable storage medium of claim 19, wherein receiving the preapproval API response further includes:
receiving the contact data associated with the user;
constructing an initial API request, wherein the initial API request includes the contact data; and
transmitting the initial API request, wherein when the initial API request is received, the resource server dynamically generates in real-time the preapproval API response, and wherein the preapproval API response includes the set of preapproved revolving accounts.
